(19) United States
(12) Patent Application Publication
(10) Pub. No.: US 2026/0127061 A1
(43) Pub. Date: May 7, 2026

(54) RELIABILITY ANALYSIS FRAMEWORK FOR NODE-LOCAL INTERMEDIARY STORAGE ARCHITECTURES

(71) Applicant: THE JOHNS HOPKINS UNIVERSITY, Baltimore, MD (US)

(72) Inventors: Antwan CLARK, Pikesville, MD (US); Nicole FLEMING, Catonsville, MD (US); Giovanni BERRIOS, Catonsville, MD (US); Yu SHAO, Waltham, MA (US); Jiawen BAI, Harrison, NJ (US)

(21) Appl. No.: 19/117,747

(22) PCT Filed: Oct. 12, 2023
(86) PCT No.: PCT/US2023/035013

§ 371 Date: Apr. 2, 2025

Related U.S. Application Data
(60) Provisional application No. 63/380,484, filed on Oct. 21, 2022.
(60) Provisional application No. 63/382,580, filed on Nov. 7, 2022.

(51) Int. Cl. G06F 11/00

(52) U.S. Cl. CPC G06F 11/008; G06F 2201/805; G06F 2201/81

(57) ABSTRACT

A method, computing device, and a non-transitory computer-readable medium are provided. The computing device determines an initial node-local burst buffer content at a start of a time period T. A current node-local burst buffer content is received by the computing device during the time period. For each checkpoint/restart time interval, the computing device: estimates stochastic transition rates λ and μ; estimates input flow data rates of data entering the node-local burst buffer from a compute node; and estimates drain data rates of the data leaving the node-local burst buffer to a parallel file system. The computing device models an average statistical reliability function of the node-local burst buffer within the time period T with respect to not exceeding a predetermined threshold value. When the average statistical reliability function has a value that is less than a predetermined threshold, the computing device performs an action.

This application is the national stage entry of International Patent Application No. PCT/US2023/035013, filed on Oct. 12, 2023, and published as WO 2024/086054 A1 on Apr. 25, 2024, which claims the benefit of U.S. Provisional Patent Application No. 63/380,484, filed Oct. 21, 2022, and U.S. Provisional Patent Application No. 63/382,580, filed Nov. 7, 2022, which are hereby incorporated by reference in their entireties.

This invention was made with United States government support under contract S900294BAH awarded by the Army Research Laboratory. The United States government has certain rights in the invention.

### BACKGROUND OF THE INVENTION

High performance computing (HPC) systems transformed the way that information is processed and stored because they can handle vast amounts of data. However, they also come with the challenge of handling input/output (I/O) bottlenecks due to the following reasons. First, big data applications running in these environments perform many read and write operations to handle workloads and thus consume much I/O bandwidth. Additionally, application-based checkpointing and restarting (C/R) is burdensome on I/O infrastructure because checkpointing operations perform a myriad number of write requests to a parallel file system (PFS) which also degrade storage server bandwidth. Job heterogeneity is also an issue because job requests of various sizes and priorities compete with each other for I/O bandwidth and other resources. This results in prolonged average I/O time because processing of smaller jobs would be delayed due to concurrent processing of larger jobs. As a result, an application C/R process is also affected because lower-priority jobs could frequently interrupt the checkpointing of higher-priority jobs. Scientists have addressed these concerns by proposing burst buffers (BBs) as brokers via developing infrastructures and algorithms to minimize effects of I/O contention in supercomputing infrastructures. One approach is to create node-local BB architectures in which each burst buffer is collocated with a corresponding compute node. This is advantageous for its scalability while also improving checkpoint bandwidth because aggregate bandwidth increases proportionally to the number of compute nodes. Since researchers at the San Diego Supercomputer Center (SDSC) illustrated this proof of concept via a DASH supercomputing cluster, several current HPCs have adopted these types of storage.

### SUMMARY OF THE INVENTION

In a first embodiment, a method is provided for performing real-time reliability analysis of node-local burst buffer architectures. A computing device determines an initial node-local burst buffer content at a start of a time period. The computing device receives a current node-local burst buffer content during the time period. For each checkpoint/restart time interval, the computing device: estimates stochastic transition rates λ and μ, indicating when the node-local burst buffer is receiving and draining, respectively; estimates input flow data rates of data entering the node-local burst buffer from a compute node; and estimates drain data rates of the data leaving the node-local burst buffer to a parallel file system. The computing device models an average statistical reliability function of the node-local burst buffer within the time period T with respect to not exceeding a predetermined threshold value. The computing device performs an action when the average statistical reliability function has a value that is less than a predefined value.

In a second embodiment, a computing device is provided for performing real-time reliability analysis of node-local burst buffer architectures. The computing device includes at least one processor, a memory connected with the at least one processor, and a node-local burst buffer. The at least one processor is configured to perform operations. According to the operations: an initial node-local burst buffer content is determined at a start of a time period T; a current node-local burst buffer content is received during the time period; for each checkpoint/restart time interval, stochastic transition rates λ and μ are estimated, indicating when the node-local burst buffer is receiving and draining, respectively, input flow data rates of data entering the node-local burst buffer from a compute node are estimated, and drain data rates of the data leaving the node-local burst buffer to be stored to a parallel file system are estimated. An average statistical reliability function of the node-local burst buffer within the time period T is modeled with respect to not exceeding a predetermined threshold value. An action is performed when the average statistical reliability function has a value that is less than a predefined value.

In a third embodiment, at least one non-transitory computer-readable storage medium has computer instructions stored thereon for a processor of a computing device to perform operations. According to the operations, an initial node-local burst buffer content at a start of a time period T is determined. A current node-local burst buffer content is received during the time period. For each checkpoint/restart time interval: stochastic transition rates λ and μ, indicating when the node-local burst buffer is receiving and draining, respectively, are estimated; input flow data rates of data entering the node-local burst buffer from a compute node are estimated; and drain data rates of the data leaving the node-local burst buffer to be stored to a parallel file system are estimated. An average statistical reliability function of the node-local burst buffer within the time period T is modeled with respect to not exceeding a predetermined threshold value. When the statistical reliability function has a value that is less than the predefined threshold value an action is performed.

### BRIEF DESCRIPTION OF THE DRAWINGS

FIG. 1 is a graph that shows an example change in node-local burst buffer content over time.

FIG. 2 is a flowchart of an example process for accessing data in a node-local burst buffer during a time interval, determining a change in node-local burst buffer content since a previous time interval, performing clustering, determining an input data flow rate of the node-local burst buffer, determining an output drain rate of the node-local burst buffer, and determining transition rates regarding the node-local burst buffer according to embodiments.

FIGS. 3 and 4 are flowcharts of an example process for counting a number of times data in the node-local burst buffer changes between entering and leaving the node-local burst buffer, and an amount of time the node-local burst buffer spends in each state according to embodiments.

FIG. 5 is a graph showing power and asymptotic expansions of a modified Bessel function of a first kind I₀.

FIG. 6 shows an example compute node according to embodiments.

### DETAILED DESCRIPTION OF THE INVENTION

Analyzing reliability of node-local burst buffers is an open problem. Prior results have not focused on direct performance of node-local burst buffers. In addition, node-local burst buffers are prone to failure and current approaches do not address this. The present application addresses these problems.

Equations 1 and 2 are stochastic processes on which a node-local framework, according to embodiments, may be based.

$${\partial }_{1} {W}^{1} + {∅}_{1} {\partial }_{x} {W}^{1} = μ {W}^{2} - λ {W}^{1} \qquad ( 1 )$$

$${\partial }_{1} {W}^{2} + {∅}_{2} {\partial }_{x} {W}^{2} = μ {W}^{1} - λ {W}^{2} \qquad ( 2 )$$

where φᵢ (i=1,2), λ=λ₁₂, and μ=λ₂₁ (to be estimated) are defined as follows: φ₁<0, φ₂>0, where |φ₁| is an output data flow rate of data leaving a node-local BB to be stored in a parallel file system (PFS) and |φ₂| is an input data rate of data entering the node-local BB from a compute node. λ=λ₁₂, λ=λ₂₁ where λ and μ are stochastic transition rates that indicate when the node-local BB is receiving data (λ=λ₁₂) and when the node-local BB is draining data (μ=λ₂₁).

During acquisition, node-local BB activity is considered in which information enters and leaves a solid state device (SSD) during a certain checkpoint/restart interval I=[0, T], where T is an end time of the interval.

Next, preprocessing and feature extraction are performed considering:

$$\frac{dQ}{dt} \approx \frac{Q ( {t}_{i + 1} ) - Q ( {t}_{i} )}{{t}_{i + 1} - {t}_{i}} \qquad ( 3 )$$

where Q represents data. The preprocessing may include 1) estimating a rate at which information enters and leaves a node local burst buffer and 2) estimating a length of time within each sub-interval in [0, T] that the node local burst buffer is receiving and draining data. Output of preprocessing includes φᵢ (i=1,2), λ=λ₁₂, λ=λ₂₁ and features are extracted related to φᵢ (i=1,2), λ=λ₁₂, and μ=λ₂₁. “t” is time.

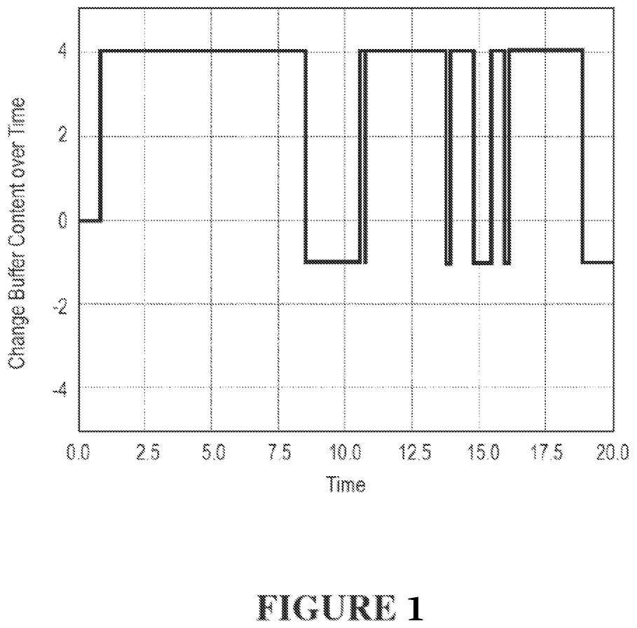

FIG. 1 shows an example change in node-local BB content over time. From a time of 0.0 to about a time of 0.625, no data is received into or drained from the node-local BB. At about the time of 0.625, four data items are received into the node-local buffer from a compute node. From about a time of 8.5 to about a time of 10.625, one data item is drained from the node-local BB to a parallel file storage (PFS). From about a time of 10.625 to about a time of 13.8, an additional four data items are received into the node-local BB from the compute node. From about the time of 13.8 to about a time of 14.95, an additional four items are received by the node-local BB from the compute node. From about the time of 14.95 to about a time of 15.5, one data item is drained from the node-local BB to the PFS. From about the time of 15.5 to about a time of 16.0, an additional four data items are received by the node-local BB from the compute node. From about the time of 16.0 to about a time of 18.8, another four data items are received into the node-local BB from the compute node. From about the time of 18.8 to about the time of 20.0, one data item is drained from the node-local BB to the PFS.

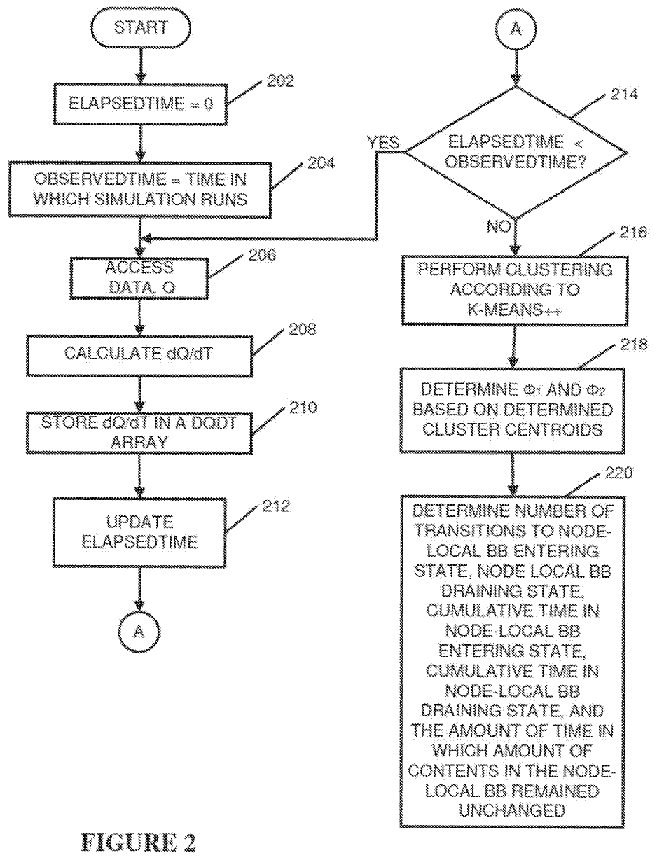

During testing, a simulator generated data for and drained data from a simulated node-local BB. FIG. 2 is a flowchart of a process for obtaining data from the simulated node-local BB. The process may begin by setting ELAPSEDTIME to zero (act 202). Next, OBSERVEDTIME is set to an amount of time in which the simulation runs (act 204) and data, Q, in the simulated node-local BB is accessed (act 206).

Next,

$$\frac{dQ}{dt} ,$$

which is a change in an amount of data, Q, over a current time step, may be determined (act 208).

$$\frac{dQ}{dt}$$

then may be stored in a DQDT array for use during clustering (act 210) and ELAPSEDTIME may be updated by an amount of a time step (act λ₁₂).

Next, a determination is made regarding whether ELAPSEDTIME is less than OBSERVEDTIME (act 214). If ELAPSEDTIME is determined to be less than OBSERVEDTIME, then acts 206-214 again may be performed during a next time interval. Otherwise, if ELAPSEDTIME is determined not to be less than OBSERVEDTIME, then the data stored in the array, at act 210, may be used for clustering according to a K-Means++ method, which differs from a K-Means method by randomly selecting one of the data items from the DQDT array as a first centroid of a first cluster.

After performing the KMeans++ method, cluster centroids are determined and each of the DQDT array items is assigned to one of a number of clusters. φ₁ and φ₂ may be estimated based on the determined cluster centroids (act 218).

Next, a number of transitions to a node-local BB entering state, a node-local BB draining state, a cumulative time in node-local BB entering state, a cumulative time in node-local BB draining state, and a cumulative time in which an amount of content in the node-local BB remained unchanged may be determined (act 220).

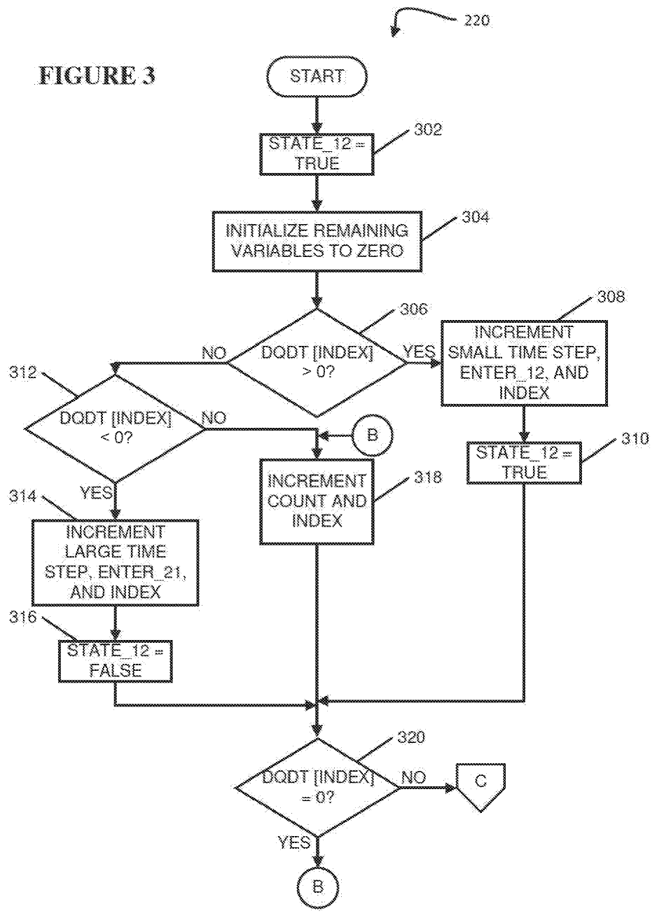

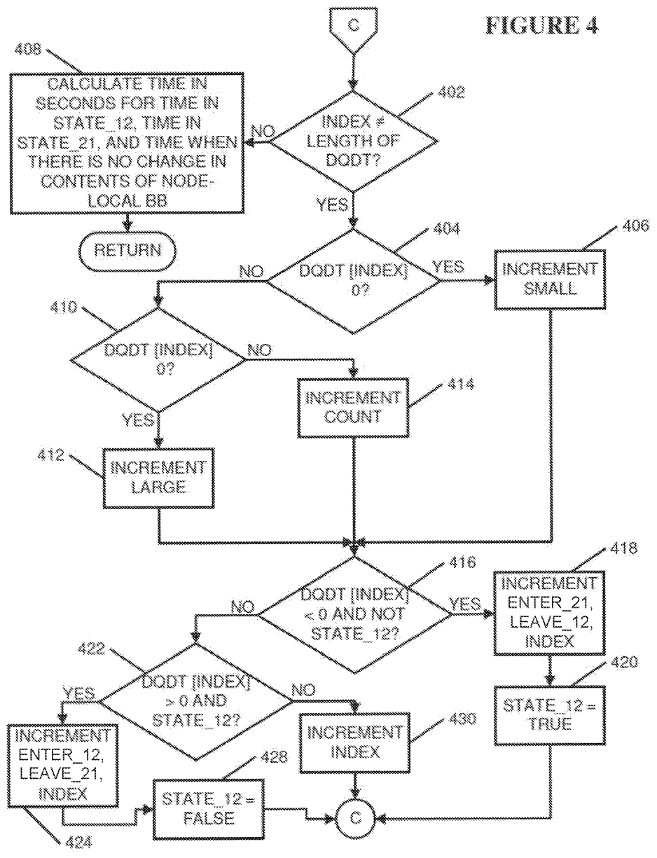

FIGS. 3 and 4 are flowcharts of a procedure that may be performed during act 220 of FIG. 2. The process may begin by setting state_12 to true, indicating that the BB is in the node-local BB receiving state in which data is received by the node-local BB from a compute node (act 302). Next, a number of variables may be initialized to zero (act 304). In some embodiments, the variables may include small, large, enter_12, leave_12, count, and index.

Next, a determination may be made regarding whether DQDT [index] is greater than zero (act 306). If DQDT [index] is determined to be greater than zero, then the node-local BB is determined to be in the node-local BB receiving state and the variable “small” may be incremented by a small time step in this embodiment, “enter_12” may be incremented to keep track of a number of intervals in which the node-local BB state is the node-local BB receiving state, and “index” may be incremented by one (act 308). State_12 then may be set to true to indicate that the node-local BB state is node-local BB receiving (act 310).

If, during act 306, DQDT [index] is determined not to be greater than zero, then a determination is made regarding whether DQDT [index] is less than zero (act 312). If DQDT [index] is determined to be less than zero, then the variable “large” may be incremented by a large time step in this embodiment, “enter_21” may be incremented by one to keep track of a number of intervals in which the node-local BB state is in the node-local BB draining state, which indicates that data has been drained from the node-local BB to the PFS, and the variable “index” may be incremented by one (act 314). The variable state_12 may be set to false to indicate that the node-local BB is in the node-local BB draining state (act 316).

If, during act 312, DQDT [index] is determined to be zero, indicating no change in contents of the node-local BB, then a variable “count”, which counts a margin of error, and the variable “index” may be incremented by one (act 318). The margin of error may be estimated by calculating statistical reliability functions and taking a norm against the theoretical statistical reliability functions.

After performing act 310, act 316, or act 318, a determination may be made regarding whether DQDT [index] is equal to zero (act 320). If DQDT [INDEX] is determined to be equal to zero, then act 318 may again be performed. Otherwise, a determination is made regarding whether index is less than a length of DQDT (i.e., whether additional items in DQDT exist for processing) (act 402; FIG. 4).

If, during act 402, additional items in DQDT are determined to exist, then a determination is made regarding whether DQDT [index]<0, indicating that the node-local BB is in the node-local BB draining state (act 404). If the DQDT [index] is determined to be less than zero, then the variable “small” for counting small time steps may be incremented by one in this embodiment (act 406).

If, during act 404, DQDT [index] is determined to not be less than zero, then a determination is made regarding whether DQDT [index] is greater than zero (act 410). If DQDT [INDEX] is determined to be greater than zero, then the variable “large” for counting large time steps may be incremented by one in this embodiment (act 412).

After performing act 406, 412, or 414, then a determination may be made regarding whether DQDT [index] is less than zero and the node-local BB state is not the node-local BB receiving state (act 416). If these conditions are true, then a variable “enter_21” may be incremented to keep track of a number of transitions to the node-local BB draining state, the variable “leave_12” may be incremented by one to keep track of a number of times a transition from the node-local BB draining state occurred, and “index” may be incremented by one so that a next item in the DQDT array may be examined (act 418). State_12 then may be set to true to indicate that the current node-local BB state is node-local BB receiving state (act 420).

If, during act 416, a determination is made that either DQDT [index] is not less than zero or state_12 is true, then a determination may be made regarding whether DQDT [index] is greater than zero and the node-local BB state is the node-local BB receiving state (state_12 is true) (act 422). If both of these conditions are determined to be true, then the variable “enter_12” may be incremented by one to keep track of a number of transitions to the node-local BB receiving state, “leave_21” may be incremented to keep track of a number of transitions from the node-local BB draining state, and “index” may be incremented by one (act 424). “State_21” then may be set to false to indicate that the node-local BB state is the node-local BB draining state (act 428).

If, during act 422, a determination is made that DQDT [index] is not greater than zero or “state_12” is false, indicating that the node-local BB state is the node-local draining state, then the variable “index” may be incremented by one.

After performing act 420, 428, or 430, act 402 again may be performed.

If, during act 402, the variable “index” is determined to be equal to the length of the DQDT array, then a time in seconds while state_12 is true, a time in seconds while in the node-local BB draining state (state_21, or state_12=false), and a time in seconds when there is no change in contents of the node-local BB may be determined.

For a stochastic estimation module, equations 1 and 2 can be expressed as

$${\partial }_{t} \vec{W} + {A}_{ϕ} {\partial }_{x} \vec{W} = {G}_{m} \vec{W} \qquad ( 4 )$$

where

$${A}_{∅} = [ \begin{matrix}{∅}_{1} & 0 \\ 0 & {∅}_{2}\end{matrix} ]$$

and Gₘ, a stochastic generator matrix, is equal to

$$[ \begin{matrix}- λ & μ \\ λ & - μ\end{matrix} ] .$$

φ₁ and φ₂ may be determined via k-means++ clustering.

The stochastic estimation (SE) module includes the following steps:
1. Use maximum likelihood estimation (MLE) as a rule of thumb to estimate λ and μ; and
2. If the estimates of λ and μ exceed a certain predefined threshold, which is chosen empirically by a user, then expectation-maximization (E-M) may be used to estimate final values of λ and μ, according to embodiments.
   a. In some embodiments, “simplified” E-M algorithms may be used (e.g., diagonal adjusted (DA) and diagonal weighted adjusted (DWA)).

According to the MLE,

$${λ}_{ij} = \frac{{N}_{ij} ( T )}{{R}_{i} ( T )} \qquad ( 5 )$$

where Nᵢⱼ(T) is a number of transitions between each state representing node-local BB behavior and Rᵢ(T) is a cumulative amount of time that the node-local BB behavior is in a particular state. Thus,

$${λ}_{12} = \frac{{N}_{12} ( T )}{{R}_{1} ( T )} ,$$

where N₁₂(T) is a number of times that the node-local BB receiving state is exited and R₁(T) is a cumulative amount of time (in seconds) in the node-local BB receiving state. Similarly,

$${λ}_{21} = μ = \frac{{N}_{21} ( T )}{{R}_{2} ( T )} ,$$

where N₂₁(T) is a number of times that the node-local BB draining state is entered and R₂(T) is a cumulative amount of time (in seconds) in which the state was the node-local buffer draining state.

If E-M is used, then

$${‖ R ( x , t ) - ‖}_{2}^{2} < ε \qquad ( 6 )$$

where R(x, t) is a theoretical reliability analysis (RA) metric, [symbol] is an actual or estimated RA metric from data, and ε is an amount of error. ε is determined to ensure that the parameters estimated, φ₁, φ₂, λ, and μ are properly chosen.

In some embodiments, when an average [symbol] (i.e. average statistical reliability function within the time period T) has a value that is less than a predefined value, an action may be performed. The action may include, but not be limited to, generating an alert to a user such as a system administrator. As a result of receiving the alert, the system administrator may perform a second action that may include, but not be limited to, shutting down access to the compute node where the node-local burst buffer resides, feeding data to a different compute node, and/or flush data from the node-local burst buffer to a parallel file system (PFS).

Similarly error checking may also be performed on the conditional statistical performance metrics W¹(x, t) and W²(x, t) to ensure robustness.

Another method for estimating transition rates λ12 and λ21 may begin by first representing in discretized form

$${δ}_{{W}^{1}}^{k + 1} = - {\tilde{λ}}_{12} {W}^{1} ( x , {t}_{k} ) + {\tilde{λ}}_{21} {W}^{2} ( x , {t}_{k} ) \qquad ( 7 )$$

$${δ}_{{W}^{2}}^{k + 1} = {\tilde{λ}}_{12} {W}^{1} ( x , {t}_{k} ) - {\tilde{λ}}_{21} {W}^{2} ( x , {t}_{k} )$$

$$where$$

$${δ}_{{W}^{1}}^{k + 1} = {W}^{m} ( x , {t}_{k + 1} ) - {W}^{m} ( x - {\hat{ϕ}}_{m} Δ t , {t}_{k} ) \qquad ( 8 )$$

for m=1, 2 and \hat{φ}ₘ are estimated transition rates.

### Additionally,

$${\tilde{λ}}_{12} = Δ t {λ}_{12} , {\tilde{λ}}_{21} = Δ t {λ}_{21} \qquad ( 9 )$$

and Δt=tₖ₊₁−tₖ∀tₖ∈ [symbol] =[0, T]. Hence, equation (7) can be expressed as

$${Δ}_{W} = A \cdot \tilde{λ} \qquad ( 10 )$$

$$where \tilde{λ} = {[ {\tilde{λ}}_{12} , {\tilde{λ}}_{21} ]}^{T} ,$$

$${Δ}_{W} = {[ {δ}_{{W}^{1}}^{1} , {δ}_{{W}^{1}}^{2} , … , {δ}_{{W}^{1}}^{N + 1} , {δ}_{{W}^{2}}^{1} , {δ}_{{W}^{2}}^{2} , … , {δ}_{{W}^{2}}^{N + 1} ]}^{T} \qquad ( 11 )$$

$$A = [ \begin{matrix}- {A}_{{W}^{1}} & {A}_{{W}^{2}} \\ {A}_{{W}_{1}} & - {A}_{{W}^{2}}\end{matrix} ] , \qquad ( 12 )$$

$${A}_{{W}^{1}} = {[ {W}^{1} ( x , {t}_{0} ) , … , {W}^{1} ( x , {t}_{N} ) ]}^{T} , \qquad ( 13 )$$

$${A}_{{W}^{2}} = {[ {W}^{2} ( x , {t}_{0} ) , … , {W}^{2} ( x , {t}_{N} ) ]}^{T} . \qquad ( 14 )$$

Employing linear least squares regression achieves

$$\tilde{λ} = {( {A}^{T} A )}^{- 1} {A}^{T} {Δ}_{W} \qquad ( 15 )$$

where λ12 and λ21 are computed directly from (9).

These metrics consider the following main cases:
1. The node-local BB is initially empty at a start of each checkpoint/restart (C/R) interval.
2. The node-local BB is initially non-empty at the start of each C/R interval.
   a. For each case, only reactive BB strategies are considered (i.e., φ₁≈φ₂).

### Equations

$${W}^{m} ( x , t ) = P \{ {Q}_{B} ( t ) \leq x \vert S ( t ) = m \} , ( m = 1 , 2 ) \qquad ( 16 )$$

$${R}_{B} ( x , t ) = P \{ {Q}_{B} ( t ) \leq x \} = {W}^{1} ( x , t ) + {W}^{2} ( x , t ) \qquad ( 17 )$$

$${F}_{B} ( x , t ) = P \{ {Q}_{B} ( t ) > x \} = 1 - {R}_{B} ( x , t ) \qquad ( 18 )$$

where R_{B}(x, t) is a theoretical reliability analysis, P{Q_{B(t)}≤x} is a probability that contents of data in the node-local BB is less than a threshold x, and F_{B}(x, t) is a failure analysis.
1. m=1: Considers the likelihood (probability) that the node-local BB is draining information to the PFS.
2. m=2: Considers the likelihood (probability) that the node-local BB is receiving information from the compute node (CN).

The equations are valid for the following cases:
Case 1: Node-local BB is initially empty at a start of each C/R interval. This case considers both proactive (|φ₁|≠|φ₂|) and reactive (|φ₁|=|φ₂|) cases.
Case 2: Node-local BB is initially non-empty at the start of each C/R interval. This case considers only reactive draining schemes (|φ₁|=|φ₂|). Specifically, only the following cases were considered:
   the initial content u is greater than a given threshold x at the start of the C/R interval (u>x).
   the initial content u is within the given threshold x at the start of the C/R interval (u≤x).

### Analytical Solutions Case 1

$${W}^{1} ( x , t ) = \{ \begin{matrix}\frac{{λ}_{21} + {λ}_{12} {e}^{- ( {λ}_{12} + {λ}_{21} ) t}}{{λ}_{12} + {λ}_{21}} , 0 < t < x / {ϕ}_{2} \\ \frac{{λ}_{21} + {λ}_{12} {e}^{- ( {λ}_{12} + {λ}_{21} ) t}}{{λ}_{12} + {λ}_{21}} - ( \frac{1}{{λ}_{21} + {λ}_{12}} ) x \\ {e}^{- \frac{{λ}_{21}}{{ϕ}_{2}} x} {\int }_{0}^{t} {f}_{1} ( t - v , x ) h ( v , x ) dv , t > x / {ϕ}_{2}\end{matrix} \qquad ( 19 )$$

$$and$$

$${W}^{2} ( x , t ) = \{ \begin{matrix}\frac{{λ}_{12}}{{λ}_{12} + {λ}_{21}} ( 1 - {e}^{- ( {λ}_{12} + {λ}_{21} ) t} ) , 0 < t \leq x / {ϕ}_{2} \\ \frac{{λ}_{12}}{{λ}_{12} + {λ}_{21}} ( 1 - {e}^{- ( {λ}_{12} + {λ}_{21} ) t} ) - ( \frac{{λ}_{12}}{{λ}_{12} + {λ}_{21}} ) \\ {xe}^{- \frac{{λ}_{21}}{{ϕ}_{2}} x} {\int }_{0}^{t} {f}_{1} ( t - v , x ) g ( v , x ) dv , t > x / {ϕ}_{2}\end{matrix} \qquad ( 20 )$$

$$where$$

$${f}_{1} ( t , x ) = 1 - {e}^{- ( {λ}_{12} + {λ}_{21} ) ( t - \frac{x}{{ϕ}_{2}} )} , \qquad ( 21 )$$

$$h ( t , x ) = \frac{{λ}_{12} {λ}_{21} {ϕ}_{2}}{( {ϕ}_{2} - {ϕ}_{1} ) ( {λ}_{12} + {λ}_{21} )} {e}^{( - \frac{{λ}_{12} {ϕ}_{2} - {λ}_{21} {ϕ}_{1}}{{ϕ}_{2} - {ϕ}_{1}} t )} \times \{ {I}_{0} ( ρ ( x , t ) ) - \frac{1}{{κ}^{2} ( x , t )} {I}_{2} ( ρ ( x , t ) ) \} , \qquad ( 22 )$$

$$g ( t , x ) = δ ( t ) + \frac{\sqrt{- {λ}_{12} {λ}_{21} {ϕ}_{2} {ϕ}_{1}}}{{ϕ}_{2} - {ϕ}_{1}} {e}^{( - \frac{{λ}_{12} {ϕ}_{2} - {λ}_{21} {ϕ}_{1}}{{ϕ}_{2} - {ϕ}_{1}} t )} \times ( κ ( x , t ) - \frac{1}{κ ( x , t )} ) {I}_{1} ( ρ ( x , t ) ) , \qquad ( 23 )$$

$$ρ ( x , t ) = \frac{2 t \sqrt{- {λ}_{12} {λ}_{21} {ϕ}_{1} {ϕ}_{2}}}{{ϕ}_{2} - {ϕ}_{1}} κ ( x , t ) , \qquad ( 24 )$$

$$and$$

$$κ ( x , t ) = \sqrt{( 1 - ( \frac{1}{{ϕ}_{1}} - \frac{1}{{ϕ}_{2}} ) \frac{x}{t} )} . \qquad ( 25 )$$

Iₙ, in equations (13) and (14), are modified Bessel functions of an order n=0, 1, and 2.

### Approximate Solutions Case 1

Approximate solutions consider the following integrals in equations (19) and (20), which include following relationships:

$${e}^{\frac{- {λ}_{21}}{{ϕ}_{2}} x} {\int }_{0}^{t} {f}_{1} ( t - v , x ) h ( v , x ) dv = {e}^{\frac{- {λ}_{21}}{{ϕ}_{2}} x} {\int }_{0}^{t} h ( v , x ) dv - {e}^{\{ - ( {λ}_{12} + {λ}_{21} ) t + \frac{{λ}_{12}}{{ϕ}_{2}} x \}} {\int }_{0}^{t} {e}^{( {λ}_{12} + {λ}_{21} ) v} h ( v , x ) dv , \qquad ( 26 )$$

$$and$$

$${e}^{- \frac{{λ}_{21}}{{ϕ}_{2}} x} {\int }_{0}^{t} {f}_{1} ( t - v , x ) g ( v , x ) dv = {e}^{\frac{- {λ}_{21}}{{ϕ}_{2}} x} {\int }_{0}^{t} g ( v , x ) dv - {e}^{\{ - ( {λ}_{12} + {λ}_{21} ) t + \frac{{λ}_{12}}{{ϕ}_{2}} x \}} {\int }_{0}^{t} {e}^{( {λ}_{12} + {λ}_{21} ) v} g ( v , x ) dv . \qquad ( 27 )$$

Approximate Solutions Case 1: Short Time Behavior for t<1 second

For short behavior, where t<1 second, equations (26) and (27) can be expressed in terms of power series representations as follows:

$${\int }_{0}^{t} h ( v , x ) dv = \frac{{λ}_{12} {λ}_{21} {ϕ}_{2}}{( {ϕ}_{2} - {ϕ}_{1} ) ( {λ}_{12} + {λ}_{21} )} {\sum }_{m = 0}^{∞} \frac{{α}^{2 m} {Ω}_{m} ( a , b , a ; x , t )}{{Γ}^{2} ( m + 1 ) {2}^{{2}_{m}}} , \qquad ( 28 )$$

$${\int }_{0}^{t} {e}^{( {λ}_{12} + {λ}_{21} ) v} h ( v , x ) dv = \frac{{λ}_{12} {λ}_{21} {ϕ}_{2}}{( {ϕ}_{2} - {ϕ}_{1} ) ( {λ}_{12} + {λ}_{21} )} {\sum }_{m = 0}^{∞} \frac{{α}^{2 m} {Ω}_{m} ( a , b , \hat{a} ; x , t )}{{Γ}^{2} ( m + 1 ) {2}^{{2}_{m}}} , \qquad ( 29 )$$

$$where$$

$${Ω}_{m} ( a , b , v ; x , t ) = {\sum }_{k = 0}^{m} ( \begin{matrix}m \\ k\end{matrix} ) \frac{{( 2 bx )}^{m - k} ( m + k ) !}{{a}^{m + k + 1}} \times \{ ( 1 - {e}^{- ν t} {\sum }_{l = 0}^{m + k} \frac{{( ν t )}^{l}}{I !} ) - \frac{{α}^{2}}{4 ( m + 1 ) ( m + 2 )} \times {\sum }_{k = 0}^{m} ( \begin{matrix}m \\ k\end{matrix} ) \frac{{( 2 bx )}^{m - k} ( m + k + 2 ) !}{{a}^{m + k + 3}} ( 1 - {e}^{- ν t} {\sum }_{l = 0}^{m + k + 2} \frac{{( ν t )}^{l}}{I !} ) \} , \qquad ( 30 )$$

and the constants a, â, b and α are defined as

$$a = \frac{{λ}_{12} {ϕ}_{2} - {λ}_{21} {ϕ}_{1}}{{ϕ}_{2} - {ϕ}_{1}} , \hat{a} = \frac{{λ}_{12} {ϕ}_{1} - {λ}_{21} {ϕ}_{2}}{{ϕ}_{2} - {ϕ}_{1}} , \qquad ( 31 )$$

$$b = - \frac{1}{2} ( \frac{1}{{ϕ}_{1}} - \frac{1}{{ϕ}_{2}} ) , and {α}^{2} = - \frac{4 {λ}_{12} {λ}_{21} {ϕ}_{1} {ϕ}_{2}}{( {ϕ}_{2} - {ϕ}_{1} )} . \qquad ( 32 )$$

### Analogously,

$${\int }_{0}^{t} g ( v , x ) dv = 1 + \frac{{λ}_{12} {λ}_{21} x}{{ϕ}_{2} - {ϕ}_{1}} {\sum }_{m = 0}^{∞} \frac{{α}^{2 m} {χ}_{m} ( a , b , a ; x , t )}{{2}^{{2}_{m}} Γ ( m + 1 ) Γ ( m + 2 )} , \qquad ( 33 )$$

$${\int }_{0}^{t} {e}^{( {λ}_{12} + {λ}_{21} ) v} g ( v , x ) dv = 1 + \frac{{λ}_{12} {λ}_{21} x}{{ϕ}_{2} - {ϕ}_{1}} {\sum }_{m = 0}^{∞} \frac{{α}^{2 m} {χ}_{m} ( a , b , \hat{a} ; x , t )}{{2}^{{2}_{m}} Γ ( m + 1 ) Γ ( m + 2 )} , \qquad ( 34 )$$

$$where$$

$${χ}_{m} ( a , b , ν ; x , t ) = {\sum }_{m = 0}^{∞} ( \begin{matrix}m \\ k\end{matrix} ) \frac{{( 2 bx )}^{m - k} ( m + k ) !}{{a}^{m + k + 1}} \times ( 1 - {e}^{- ν t} {\sum }_{i = 0}^{m + k} \frac{{( ν t )}^{l}}{I !} ) , \qquad ( 35 )$$

and the constants a, â, b and α are defined by equations (31) and (32), respectively.
Approximate Solutions Case 1: Long Time Behavior for t≥1 Second

For long time behavior where t≥1 second, this results in asymptotic representations a follows:

$${\int }_{0}^{t} h ( v , x ) dv \sim \frac{{λ}_{12} {λ}_{21} {ϕ}_{2}}{\sqrt{2 πα} ( {ϕ}_{2} - {ϕ}_{1} ) ( {λ}_{12} + {λ}_{21} )} \times ( {\int }_{0}^{t} \frac{{e}^{- av + {α ( {v}^{2} + 2 bxv )}^{\frac{1}{2}}}}{{( {v}^{2} + 2 bxv )}^{\frac{1}{4}}} dv - {\sum }_{m = 0}^{∞} \frac{{( - 1 )}^{m} {2}^{{2}_{m}}}{( 2 m ) !! {α}^{m}} {\int }_{0}^{t} \frac{{e}^{- av + {α ( {v}^{2} + 2 bxv )}^{\frac{1}{2}}}}{{{v}^{\frac{m}{2} + \frac{5}{4}} ( v + 2 bx )}^{\frac{m}{2} - \frac{3}{4}}} dv ) , \qquad ( 36 )$$

$${\int }_{0}^{t} {e}^{( {λ}_{12} + {λ}_{21} ) v} h ( v , x ) dv \sim \frac{{λ}_{12} {λ}_{21} {ϕ}_{2}}{\sqrt{2 πα} ( {ϕ}_{2} - {ϕ}_{1} ) ( {λ}_{12} + {λ}_{21} )} \times ( {\int }_{0}^{t} \frac{{e}^{- \hat{a} v + {α ( {v}^{2} + 2 bxv )}^{\frac{1}{2}}}}{{( {v}^{2} + 2 bxv )}^{\frac{1}{4}}} dv - {\sum }_{m = 0}^{∞} \frac{{( - 1 )}^{m} {2}^{{2}_{m}}}{( 2 m ) !! {α}^{m}} {\int }_{0}^{t} \frac{{e}^{- \hat{a} v + {α ( {v}^{2} + 2 bxv )}^{\frac{1}{2}}}}{{{v}^{\frac{m}{2} + \frac{5}{4}} ( v + 2 bx )}^{\frac{m}{2} - \frac{3}{4}}} dv ) , \qquad ( 37 )$$

$$and$$

$${\int }_{0}^{t} g ( v , x ) dv \sim 1 + \frac{bx \sqrt{α}}{\sqrt{2 π}} {\sum }_{m = 0}^{∞} \frac{{( - 1 )}^{m}}{( 2 m ) !! α} {\int }_{0}^{t} \frac{{e}^{- av + {α ( {v}^{2} + 2 bxv )}^{\frac{1}{2}}}}{{( {v}^{2} + 2 bxv )}^{\frac{m}{2} + \frac{3}{4}}} dv , \qquad ( 38 )$$

$${\int }_{0}^{t} {e}^{( {λ}_{12} + {λ}_{21} ) v} g ( v , x ) dv \sim 1 + \frac{bx \sqrt{α}}{\sqrt{2 π}} {\sum }_{m = 0}^{∞} \frac{{( - 1 )}^{m}}{( 2 m ) !! α} {\int }_{0}^{t} \frac{{e}^{- \hat{a} v + {α ( {v}^{2} + 2 bxv )}^{\frac{1}{2}}}}{{( {v}^{2} + 2 bxv )}^{\frac{m}{2} + \frac{3}{4}}} dv , \qquad ( 39 )$$

where the constants a, â, b and α are defined by equations (31) and (32), respectively.

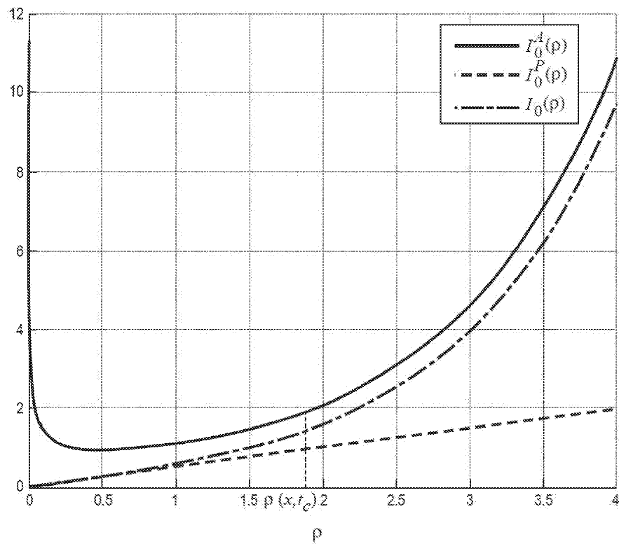

FIG. 5 shows power and asymptotic expansions of the Bessel Function I₀. A critical point t_{c} may be estimated from

$${‖ {I}_{n} ( ρ ( x , {t}_{c} ) ) - {I}_{n}^{P} ( ρ ( x , {t}_{c} ) ) ‖}_{2} - {‖ {I}_{n} ( ρ ( x , {t}_{c} ) ) - {I}_{n}^{A} ( ρ ( x , {t}_{c} ) ) ‖}_{2} < ϵ , \qquad ( 40 )$$

where Iₙ(ρ(x, t_{c})) is a modified Bessel function of order n=0, 1,

$${I}_{n}^{P} ( ρ ( x , {t}_{c} ) )$$

is a power series of a modified Bessel function of order n=0, 1,

$${I}_{n}^{A} ( ρ ( x , {t}_{c} ) )$$

is the asymptotic series of a modified Bessel function of n=0, 1, and ϵ=1×10⁻⁶ is an error tolerance.

This critical point is a transition point between power series and asymptotic expansion. Next, the power series and asymptotic representations of equations (26) and (27) may be fused into equations (19) and (20) to consider the behavior of t. See Appendix A for a computation of

$${I}_{n}^{P} ( ρ ( x , {t}_{c} ) ) and {I}_{n}^{A} ( ρ ( x , {t}_{c} ) )$$

(n=0,1).
Analytical Solutions Case 2 [u>x]

$$( i ) When 0 < t \leq {v}_{0} \\ {W}^{1} ( x , t ) = {W}^{2} ( x , t ) = 0. \qquad ( 41 )$$

$$( ii ) When {v}_{0} < t \leq {\tilde{v}}_{0} \\ {W}^{1} ( x , t ) = \frac{{λ}_{21}}{2 ( {λ}_{12} + {λ}_{21} )} {e}^{- \frac{( {λ}_{12} - {λ}_{21} ) ( u - x )}{2 ϕ}} \times \{ 2 {e}^{- a ( t - {v}_{0} )} sinh [ a ( t - {v}_{0} ) ] + {e}^{- at} ( {λ}_{21} - {λ}_{12} ) {\int }_{{v}_{0}}^{t} sinh [ a ( v - t ) ] {t}_{0} [ α y ( v ) ] dv - 2 {e}^{- at} {\int }_{{v}_{0}}^{t} \frac{α {v}_{0} sinh [ a ( v - t ) ]}{y ( v )} {I}_{1} [ α y ( v ) ] dv \} \qquad ( 42 )$$

$$and$$

$${W}^{2} ( x , t ) = \frac{{e}^{- \frac{( {λ}_{12} - {λ}_{21} ) ( u - x )}{2 ϕ}}}{2 ( {λ}_{12} + {λ}_{21} )} \times \{ {\int }_{{v}_{0}}^{t} \frac{( {λ}_{21} {e}^{a ( v - 2 t )} + {λ}_{12} {e}^{- av} ) α {v}_{0}}{y ( v )} {I}_{1} [ α y ( v ) ] dv - \frac{( {λ}_{12} - {λ}_{21} )}{2} {\int }_{{v}_{0}}^{t} ( {λ}_{21} {e}^{a ( v - 2 t )} + {λ}_{12} {e}^{- av} ) {I}_{0} [ α y ( v ) ] dv + ( {λ}_{21} {e}^{a ( {v}_{0} - 2 t )} + {λ}_{12} {e}^{- {av}_{0}} ) - ( {λ}_{12} + {λ}_{21} ) {e}^{- at} {I}_{0} [ α y ( v ) ] \} . \qquad ( 43 )$$

$$( iii ) When t > {\tilde{v}}_{0} \\ {W}^{1} ( x , t ) = \frac{{e}^{- \frac{( {λ}_{12} - {λ}_{21} ) ( u - x )}{2 ϕ}}}{{λ}_{12} + {λ}_{21}} ( {λ}_{21} {e}^{- a ( t - {v}_{0} )} sinh [ a ( t - {v}_{0} ) ] + \frac{{λ}_{21}^{2} {e}^{a ( {\tilde{v}}_{0} - 2 t )}}{2 {λ}_{12}} - \frac{{λ}_{12} {e}^{- a {\tilde{v}}_{0}}}{2} + \frac{\hat{η} ( t )}{2 {λ}_{12}} ) + \frac{{e}^{- [ \frac{( {λ}_{12} - {λ}_{21} ) ( u - x )}{2 ϕ} + at ]}}{{λ}_{12}} \times ( \frac{α t}{y ( t )} {I}_{1} [ α \tilde{y} ( t ) ] + \frac{( {λ}_{12} - {λ}_{21} ) {I}_{0} [ α \tilde{y} ( t ) ]}{2} - {α}^{2} {\tilde{v}}_{0} ) \qquad ( 44 )$$

$$and$$

$${W}^{2} ( x , t ) = \frac{{e}^{- \frac{( {λ}_{12} - {λ}_{21} ) ( u - x )}{2 ϕ}}}{{λ}_{12} + {λ}_{21}} \times \{ sinh [ \frac{ax}{ϕ} ] ( {λ}_{12} {e}^{- \frac{au}{ϕ}} - {λ}_{21} {e}^{- \frac{a ( u - 2 t )}{ϕ}} ) + \frac{( {λ}_{12} + {λ}_{21} ) {e}^{- at}}{2} ( {I}_{0} [ α \tilde{y} ( t ) ] + {I}_{0} [ α y ( t ) ] ) + \tilde{β} ( t ) \} , \qquad ( 45 )$$

$$where$$

$$a = \frac{( {λ}_{12} + {λ}_{21} )}{2} , α = \sqrt{{λ}_{12} {λ}_{21}} , \qquad ( 46 )$$

$${v}_{0} = \frac{1}{ϕ} ( u - x ) , {\tilde{v}}_{0} = \frac{1}{ϕ} ( u + x ) , \qquad ( 47 )$$

$$y ( t ) = \sqrt{{t}^{2} - {v}_{0}^{2}} , \tilde{y} ( t ) = \sqrt{{t}^{2} - {\tilde{v}}_{0}^{2}} , \qquad ( 48 )$$

$$\tilde{η} ( t ) = {α}^{2} {\int }_{{v}_{0}}^{t} \{ ( {λ}_{21} - {λ}_{12} ) {I}_{0} [ α y ( v ) ] - \frac{2 α {v}_{0} {I}_{1} [ α y ( v ) ]}{y ( v )} \} {e}^{- at} sinh [ a ( t - v ) ] dv + ( {λ}_{12} - {λ}_{21} ) {\int }_{{\tilde{v}}_{0}}^{t} ( {λ}_{21}^{2} {e}^{a ( v - 2 t )} - {λ}_{12}^{2} {e}^{- av} ) {I}_{0} [ α \tilde{y} ( v ) ] dv + {\int }_{{\tilde{v}}_{0}}^{t} \frac{α {\tilde{v}}_{0}}{\tilde{y} ( v )} ( {λ}_{21}^{2} {e}^{a ( v - 2 t )} - {λ}_{12}^{2} {e}^{- av} ) {I}_{1} [ α \tilde{y} ( v ) ] dv , \qquad ( 49 )$$

$$and$$

$$\tilde{β} ( t ) = \frac{1}{4} {\int }_{{v}_{0}}^{t} ( {λ}_{21} {e}^{a ( v - 2 t )} + {λ}_{12} {e}^{- av} ) \times [ {I}_{0} [ α y ( v ) ] ( {λ}_{21} - {λ}_{12} ) - \frac{2 α {\tilde{v}}_{0} {I}_{0} [ α y ( v ) ]}{y ( v )} ] dv + \frac{1}{4} {\int }_{{\tilde{v}}_{0}}^{t} ( {λ}_{21} {e}^{a ( v - 2 t )} + {λ}_{12} {e}^{- av} ) [ {I}_{0} [ α \tilde{y} ( v ) ] ( {λ}_{21} - {λ}_{12} ) - \frac{2 α {\tilde{v}}_{0} {I}_{1} [ α \tilde{y} ( v ) ]}{\tilde{y} ( v )} ] dv , \qquad ( 50 )$$

Approximate Solutions Case 2 [u>x]: t<1 second

$$( 1 ) When 0 < t \leq {v}_{0} \\ {W}^{1} ( x , t ) = {W}^{2} ( x , t ) = 0. \qquad ( 51 )$$

$$( ii ) when {v}_{0} < t \leq {\tilde{v}}_{0} \\ {W}^{1} ( x , t ) = \frac{{λ}_{21} {e}^{- \frac{( {λ}_{12} - {λ}_{21} ) ( u - x )}{2 ϕ}}}{{λ}_{12} + {λ}_{21}} \times \{ ( 1 - {e}^{- 2 a ( t - {v}_{0} )} ) - \frac{{λ}_{12} - {λ}_{21}}{2} {\sum }_{k = 0}^{∞} \frac{1}{{[ Γ ( k + 1 ) ]}^{2}} {( \frac{α}{2} )}^{2 k} ( {Ω}_{k} ( t , {v}_{0} , - a ) - {e}^{- 2 at} {Ω}_{k} ( t , {v}_{0} , a ) ) + \frac{{α}^{2} {v}_{0}}{2} {\sum }_{k = 0}^{∞} \frac{1}{[ Γ ( k + 1 ) Γ ( k + 2 ) ]} {( \frac{α}{2} )}^{2 k} ( {Ω}_{k} ( t , {v}_{0} , - a ) - {e}^{- 2 at} {Ω}_{k} ( t , {v}_{0} , a ) ) \} \qquad ( 52 )$$

$${W}^{2} ( x , t ) = {e}^{- \frac{( {λ}_{12} - {λ}_{21} ) ( u - x )}{2 ϕ}} \times \{ \frac{{λ}_{21} {e}^{- 2 ut + {v}_{0}} + {λ}_{12} {e}^{- {av}_{0}}}{2 ( {λ}_{12} + {λ}_{21} )} - \frac{1}{2} {e}^{- at} {\sum }_{k = 0}^{∞} \frac{1}{{[ Γ ( k + 1 ) ]}^{2}} {( \frac{α y ( t )}{2} )}^{2 k} + \frac{{α}^{2} {v}_{0}}{2 ( {λ}_{12} + {λ}_{21} )} {\sum }_{k = 0}^{∞} \frac{1}{[ Γ ( k + 1 ) Γ ( k + 2 ) ]} {( \frac{α}{2} )}^{2 k} ( \frac{{λ}_{12}}{2} {Ω}_{k} ( t , {v}_{0} , - a ) + \frac{{λ}_{21}}{2} {e}^{- 2 at} {Ω}_{k} ( t , {v}_{0} , a ) ) \} \qquad ( 53 )$$

$$( iii ) when t > {\tilde{v}}_{0} \\ {W}^{1} ( x , t ) = {e}^{- \frac{( {λ}_{12} - {λ}_{21} ) ( u - x )}{2 ϕ}} \times \{ \frac{{λ}_{21}}{2 ( {λ}_{12} + {λ}_{21} )} ( 1 - {e}^{- 2 at ( t - {v}_{0} )} ) - \frac{{λ}_{12}}{2 ( {λ}_{12} + {λ}_{21} )} - {e}^{a {\tilde{v}}_{0}} + \frac{{λ}_{21}^{2}}{2 {λ}_{12} ( {λ}_{12} + {λ}_{21} )} {e}^{a ( {\tilde{v}}_{0} - 2 t )} + {e}^{- at} ( \frac{{α}^{2} t}{2 {λ}_{12}} {\sum }_{k = 0}^{∞} \frac{1}{[ Γ ( k + 1 ) Γ ( k + 2 ) ]} {( \frac{α \tilde{y} ( t )}{2} )}^{2 k} + \frac{{λ}_{12} - {λ}_{21}}{2 {λ}_{12}} {\sum }_{k = 0}^{∞} \frac{1}{{[ Γ ( k + 1 ) ]}^{2}} {( \frac{α \tilde{y} ( t )}{2} )}^{2 k} - \frac{{α}^{2} {\tilde{v}}_{0}}{2 {λ}_{12}} ) - \frac{{λ}_{21} ( {λ}_{12} - {λ}_{21} )}{4 ( {λ}_{12} + {λ}_{21} )} {\sum }_{k = 0}^{∞} \frac{1}{{[ Γ ( k + 1 ) ]}^{2}} {( \frac{α}{2} )}^{2 k} ( {Ω}_{k} ( t , {v}_{0} , - a ) - {e}^{2 at} {Ω}_{k} ( t , {v}_{0} , a ) ) + \frac{{λ}_{21} {α}^{2} {v}_{0}}{4 ( {λ}_{12} + {λ}_{21} )} {\sum }_{k = 0}^{∞} \frac{1}{[ Γ ( k + 1 ) Γ ( k + 2 ) ]} {( \frac{α}{2} )}^{2 k} ( {Ω}_{k} ( t , {v}_{0} , - a ) - {e}^{2 at} {Ω}_{k} ( t , {v}_{0} , a ) ) + \frac{( {λ}_{12} - {λ}_{21} )}{2 ( {λ}_{12} + {λ}_{21} )} {\sum }_{k = 0}^{∞} \frac{1}{{[ Γ ( k + 1 ) ]}^{2}} {( \frac{α}{2} )}^{2 k} ( \frac{{λ}_{12}}{2} {Ω}_{k} ( t , {\tilde{v}}_{0} , - a ) - \frac{{λ}_{21}^{2}}{2 {λ}_{12}} {e}^{- at} {Ω}_{k} ( t , {\tilde{v}}_{0} , a ) ) \frac{{α}^{2} {v}_{0}}{2 ( {λ}_{12} + {λ}_{21} )} {\sum }_{k = 0}^{∞} \frac{1}{[ Γ ( k + 1 ) Γ ( k + 2 ) ]} {( \frac{α}{2} )}^{2 k} ( \frac{{λ}_{12}}{2} {Ω}_{k} ( t , {\tilde{v}}_{0} , - a ) - \frac{{λ}_{21}^{2}}{2 {λ}_{12}} {e}^{- at} {Ω}_{k} ( t , {\tilde{v}}_{0} , a ) ) \} \qquad ( 54 )$$

$$and$$

$${W}^{2} ( x , t ) = {e}^{- \frac{( {λ}_{12} - {λ}_{21} ) ( u - x )}{2 ϕ}} \times \{ \frac{{λ}_{21} {e}^{a ( {v}_{0} - 2 t )} + {λ}_{12} {e}^{- {av}_{0}}}{2 ( {λ}_{12} + {λ}_{21} )} - \frac{{λ}_{21} {e}^{a ( {\tilde{v}}_{0} - 2 t )} + {λ}_{12} {e}^{- a {\tilde{v}}_{0}}}{2 ( {λ}_{12} + {λ}_{21} )} - \frac{1}{2} {e}^{- at} {\sum }_{k = 0}^{∞} \frac{1}{{[ Γ ( k + 1 ) ]}^{2}} {( \frac{α y ( t )}{2} )}^{2 k} + \frac{1}{2} {e}^{- at} {\sum }_{k = 0}^{∞} \frac{1}{{[ Γ ( k + 1 ) ]}^{2}} {( \frac{α \tilde{y} ( t )}{2} )}^{2 k} + \frac{{α}^{2} {v}_{0}}{2 ( {λ}_{12} + {λ}_{21} )} {\sum }_{k = 0}^{∞} \frac{1}{[ Γ ( k + 1 ) Γ ( k + 2 ) ]} {( \frac{α}{2} )}^{2 k} ( \frac{{λ}_{12}}{2} {Ω}_{k} ( t , {\tilde{v}}_{0} , a ) + \frac{{λ}_{21}}{2} {e}^{- 2 at} {Ω}_{k} ( t , {\tilde{v}}_{0} , a ) ) - \frac{( {λ}_{12} - {λ}_{21} )}{2 ( {λ}_{12} + {λ}_{21} )} {\sum }_{k = 0}^{∞} \frac{1}{{[ Γ ( k + 1 ) ]}^{2}} {( \frac{α}{2} )}^{2 k} ( \frac{{λ}_{12}}{2} {Ω}_{k} ( t , {\tilde{v}}_{0} , a ) + \frac{{λ}_{21}}{2} {e}^{- 2 at} {Ω}_{k} ( t , {\tilde{v}}_{0} , a ) ) - \frac{{α}^{2} {v}_{0}}{2 ( {λ}_{12} + {λ}_{21} )} {\sum }_{k = 0}^{∞} \frac{1}{[ Γ ( k + 1 ) Γ ( k + 2 ) ]} {( \frac{α}{2} )}^{2 k} ( \frac{{λ}_{12}}{2} {Ω}_{k} ( t , {\tilde{v}}_{0} , a ) + \frac{{λ}_{21}}{2} {e}^{- 2 at} {Ω}_{k} ( t , {\tilde{v}}_{0} , a ) ) + \frac{( {λ}_{12} - {λ}_{21} )}{2 ( {λ}_{12} + {λ}_{21} )} {\sum }_{k = 0}^{∞} \frac{1}{{[ Γ ( k + 1 ) ]}^{2}} {( \frac{α}{2} )}^{2 k} ( \frac{{λ}_{12}}{2} {Ω}_{k} ( t , {\tilde{v}}_{0} , a ) + \frac{{λ}_{21}}{2} {e}^{- 2 at} {Ω}_{k} ( t , {\tilde{v}}_{0} , a ) ) \} \qquad ( 55 )$$

$$where$$

$${Ω}_{k} ( t ; {v}_{0} , a ) = {\sum }_{i = 0}^{k} {( - 1 )}^{k - i} ( \begin{matrix}k \\ i\end{matrix} ) {v}_{0}^{2 ( k - i )} \frac{( 2 i + 1 ) !}{{a}^{2 i + 1}} ( {\sum }_{m = 0}^{2 i} \frac{{( - a )}^{m}}{m !} ( {t}^{m} {e}^{at} - {v}_{0}^{m} {e}^{{av}_{0}} ) ) \qquad ( 56 )$$

$$and$$

$${Ω}_{k} ( t , {v}_{0} , - a ) = {\sum }_{i = 0}^{k} {( - 1 )}^{k - i} ( \begin{matrix}k \\ i\end{matrix} ) {v}_{0}^{2 ( k - i )} \frac{( 2 i + 1 ) !}{{( - a )}^{2 i + 1}} ( {\sum }_{m = 0}^{2 i} \frac{{a}^{m}}{m !} ( {t}^{m} {e}^{at} - {v}_{0}^{m} {e}^{- {av}_{0}} ) ) . \qquad ( 57 )$$

Note: Ωₖ(t; \tilde{v}₀, a) and Ωₖ(t; \tilde{v}₀, −a) can be found by substituting \tilde{v}₀ for v₀ in equations (56) and (57), respectively.
Approximate Solutions Case 2 [u>x]: t≥1

$${W}^{1} ( x , t ) = {e}^{- \frac{( {λ}_{12} - {λ}_{21} ) ( u - x )}{2 ϕ}} \times \{ \frac{{λ}_{21}}{2 ( {λ}_{12} + {λ}_{21} )} ( 1 - {e}^{- 2 a ( t - {v}_{0} )} ) - \frac{{λ}_{12}}{2 ( {λ}_{12} + {λ}_{21} )} - {e}^{a {\tilde{v}}_{0}} + \frac{{λ}_{21}^{2}}{2 {λ}_{12} ( {λ}_{12} + {λ}_{21} )} {e}^{a ( {\tilde{v}}_{0} - 2 t )} + {e}^{- at} \frac{1}{\sqrt{2 πα}} ( \frac{α t}{{λ}_{12}} \frac{{e}^{α y ( t )}}{{[ y ( t ) ]}^{3 / 2}} + \frac{{λ}_{12} - {λ}_{21}}{2 {λ}_{12}} \frac{{e}^{α y ( t )}}{{[ y ( t ) ]}^{1 / 2}} - \frac{{α}^{2} {\tilde{v}}_{0}}{2 {λ}_{12}} ) \frac{{λ}_{12} ( {λ}_{12} - {λ}_{21} )}{2 ( {λ}_{12} + {λ}_{21} )} ( \frac{1}{2} {χ}_{- 1} ( t ; {v}_{0} , a ) - \frac{1}{2} {e}^{- at} {χ}_{- 1} ( t ; {v}_{0} , a ) ) + \frac{{λ}_{12}}{2 ( {λ}_{12} + {λ}_{21} )} {\sum }_{k = 0}^{∞} \frac{{( - 1 )}^{k} α {v}_{0}}{( 2 k ) !! {α}^{k}} ( {χ}_{k} ( t ; {v}_{0} , a ) - {e}^{- 2 at} {χ}_{k} ( t ; {v}_{0} , a ) ) + \frac{( {λ}_{12} - {λ}_{21} )}{2 ( {λ}_{12} + {λ}_{21} )} ( \frac{{λ}_{12}}{2} {χ}_{- 1} ( t ; {v}_{0} , a ) - \frac{{λ}_{21}^{2}}{2 {λ}_{12}} {e}^{- 2 at} {χ}_{- 1} ( t ; {v}_{0} , a ) ) - \frac{{λ}_{12}}{2 ( {λ}_{12} + {λ}_{21} )} {\sum }_{k = 0}^{∞} \frac{{( - 1 )}^{k} α {\tilde{v}}_{0}}{( 2 k ) !! {α}^{k}} ( \frac{{λ}_{12}}{2} {χ}_{k} ( t ; {v}_{0} , a ) - \frac{{λ}_{12}^{2}}{2 {λ}_{12}} {e}^{- 2 at} {χ}_{k} ( t ; {\tilde{v}}_{0} , a ) ) \} \qquad ( 58 )$$

$${W}^{2} ( x , t ) = {e}^{- \frac{( {λ}_{12} - {λ}_{21} ) ( u - x )}{2 ϕ}} \times \{ \frac{{λ}_{21} {e}^{a ( {v}_{0} - 2 t )} + {λ}_{12} {e}^{- {av}_{0}}}{2 ( {λ}_{12} + {λ}_{21} )} - \frac{{λ}_{21} {e}^{a ( {\tilde{v}}_{0} - 2 t )} + {λ}_{12} {e}^{- a {\tilde{v}}_{0}}}{2 ( {λ}_{12} + {λ}_{21} )} - {e}^{- at} \frac{1}{\sqrt{2 πα}} ( \frac{{e}^{α y ( t )}}{{[ y ( t ) ]}^{1 / 2}} + \frac{{e}^{α \tilde{y} ( t )}}{{[ \tilde{y} ( t ) ]}^{1 / 2}} ) + \frac{1}{2 ( {λ}_{12} + {λ}_{21} )} {\sum }_{k = 0}^{∞} \frac{{( - 1 )}^{k} α {v}_{0}}{( 2 k ) !! {α}^{k}} ( \frac{{λ}_{12}}{2} {χ}_{k} ( t ; {v}_{0} , a ) + \frac{{λ}_{21}}{2} {e}^{- 2 at} {χ}_{k} ( t ; {v}_{0} , a ) ) - \frac{( {λ}_{12} - {λ}_{21} )}{2 ( {λ}_{12} + {λ}_{21} )} ( \frac{{λ}_{12}}{2} {χ}_{- 1} ( t ; {v}_{0} , a ) + \frac{{λ}_{21}}{2} {e}^{- 2 at} {χ}_{- 1} ( t ; {v}_{0} , a ) ) - \frac{1}{2 ( {λ}_{12} + {λ}_{21} )} {\sum }_{k = 0}^{∞} \frac{{( - 1 )}^{k} α {\tilde{v}}_{0}}{( 2 k ) !! {α}^{k}} ( \frac{{λ}_{12}}{2} {χ}_{k} ( t ; {\tilde{v}}_{0} , a ) + \frac{{λ}_{21}}{2} {e}^{- 2 at} {χ}_{k} ( t ; {\tilde{v}}_{0} , a ) ) + \frac{( {λ}_{12} - {λ}_{21} )}{2 ( {λ}_{12} + {λ}_{21} )} ( \frac{{λ}_{12}}{2} {χ}_{- 1} ( t ; {v}_{0} , a ) + \frac{{λ}_{21}}{2} {e}^{- 2 at} {χ}_{- 1} ( t ; {v}_{0} , a ) ) \} \qquad ( 59 )$$

$$where$$

$${χ}_{k} ( t ; {v}_{0} , a ) = \sqrt{\frac{1}{2 πα}} {\int }_{{v}_{0}}^{t} \frac{{e}^{av + α y ( v )}}{{[ y ( v ) ]}^{k + 3 / 2}} \qquad ( 60 )$$

$${χ}_{k} ( t ; {v}_{0} , - a ) = \sqrt{\frac{1}{2 πα}} {\int }_{{v}_{0}}^{t} \frac{{e}^{- av + α y ( v )}}{{[ y ( v ) ]}^{k + 3 / 2}} \qquad ( 61 )$$

$${χ}_{- 1} ( t ; {v}_{0} , a ) = \sqrt{\frac{1}{2 πα}} {\int }_{{v}_{0}}^{t} \frac{{e}^{av + α y ( v )}}{{[ y ( v ) ]}^{1 / 2}} \qquad ( 62 )$$

$${χ}_{- 1} ( t ; {v}_{0} , - a ) = \sqrt{\frac{1}{2 πα}} {\int }_{{v}_{0}}^{t} \frac{{e}^{- av + α y ( v )}}{{[ y ( v ) ]}^{1 / 2}} \qquad ( 63 )$$

χₖ(t; \hat{v}₀, a), χₖ(t; \tilde{v}₀, −a), χ₋₁(t; \tilde{v}₀, a), and χ₋₁(t; \ddot{v}₀, −a) can be found by substituting \hat{v}₀ for v₀ into equations (60)-(63), respectively.
Approximate Solutions Case 2 [u>x]: Comprehensive Expansion

The critical point the is estimated from

$${‖ {I}_{n} ( y ( {t}_{c} ) ) - {I}_{n}^{P} ( y ( {t}_{c} ) ) ‖}_{2} - {‖ {I}_{n} ( y ( {t}_{c} ) ) - {I}_{n}^{A} ( y ( {t}_{c} ) ) ‖}_{2} < ϵ , \qquad ( 64 )$$

$${‖ {I}_{n} ( \tilde{y} ( {\tilde{t}}_{c} ) ) - {I}_{n}^{P} ( \tilde{y} ( {\tilde{t}}_{c} ) ) ‖}_{2} - {‖ {I}_{n} ( \tilde{y} ( {\tilde{t}}_{c} ) ) - {I}_{n}^{A} ( \tilde{y} ( {\tilde{t}}_{c} ) ) ‖}_{2} < ϵ , \qquad ( 65 )$$

where Iₙ(y(t_{c})) and Iₙ(\tilde{y}(\tilde{t}_{c})) are modified Bessel functions of order n=0, 1,

$${I}_{n}^{P} ( y ( {t}_{c} ) ) and {I}_{n}^{P} ( \tilde{y} ( {\tilde{t}}_{c} ) )$$

are power series of the modified Bessel functions of order n=0, 1,

$${I}_{n}^{A} ( y ( {t}_{c} ) ) and {I}_{n}^{A} ( \tilde{y} ( {\tilde{t}}_{c} ) )$$

are asymptotic series of the modified Bessel function of order n=0, 1, and ϵ=1×10⁻⁶ is an error tolerance.

This critical point is a transition point between power series and asymptotic expansion.

Next, the power series and the asymptotic representations of equations (26) and (27) may be fused into equations (41)-(45) to consider the behavior of t.

See Appendix A for a computation of

$${I}_{n}^{P} ( y ( {t}_{c} ) ) , {I}_{n}^{P} ( \tilde{y} ( {\tilde{t}}_{c} ) ) , {I}_{n}^{A} ( y ( {t}_{c} ) ) and {I}_{n}^{A} ( \tilde{y} ( {\tilde{t}}_{c} ) )$$

n=(0, 1).
Analytical Solution Case 2: [u≤x]

$$( i ) when 0 < t < {v}_{0} \qquad ( 66 )$$

$${W}^{1} ( x , t ) = \frac{{λ}_{21}}{{λ}_{12} + {λ}_{21}} ( 1 - {e}^{- ( {λ}_{12} + {λ}_{21} ) t} )$$

$${W}^{2} ( x , t ) = \frac{{λ}_{12}}{{λ}_{12} + {λ}_{21}} + \frac{{λ}_{21}}{{λ}_{12} + {λ}_{21}} ( 1 - {e}^{- ( {λ}_{12} + {λ}_{21} ) t} )$$

$$( ii ) when {v}_{0} < t < {\tilde{v}}_{0} \qquad ( 67 )$$

$${W}^{1} ( x , t ) = \frac{{λ}_{21}}{{λ}_{12} + {λ}_{21}} ( 1 - {e}^{- ( {λ}_{12} + {λ}_{21} ) t} ) - ( {g}_{14} ( x , t ) + {g}_{15} ( x , t ) + {g}_{17} ( x , t ) )$$

$${W}^{2} ( x , t ) = \frac{{λ}_{12}}{{λ}_{12} + {λ}_{21}} + \frac{{λ}_{21}}{{λ}_{12} + {λ}_{21}} ( 1 - {e}^{- ( {λ}_{12} + {λ}_{21} ) t} ) - {e}^{( x - u ) \frac{( {λ}_{12} - {λ}_{21} )}{2 ϕ}} ( \text{} {g}_{22} ( x , t ) + {g}_{25} ( x , t ) + {g}_{27} ( x , t ) + {g}_{29} ( x , t ) + {g}_{210} ( x , t ) + {g}_{211} ( x , t ) + {g}_{212} ( x , t ) )$$

$$when t < {\tilde{v}}_{0} \qquad ( 70 )$$

$${W}^{1} ( x , t ) = \frac{{λ}_{21}}{{λ}_{12} + {λ}_{21}} ( 1 - {e}^{- ( {λ}_{12} + {λ}_{21} ) t} ) + {e}^{( x - u ) \frac{( {λ}_{12} - {λ}_{21} )}{2 ϕ}} ( {g}_{110} ( x , t ) - {g}_{113} ( x , t ) - {g}_{14} ( x , t ) + {g}_{15} ( x , t ) + {g}_{17} ( x , t ) )$$

$$( 71 )$$

$${W}^{2} ( x , t ) = \frac{{λ}_{12}}{{λ}_{12} + {λ}_{21}} + \frac{{λ}_{21}}{{λ}_{12} + {λ}_{21}} ( 1 - {e}^{- ( {λ}_{12} + {λ}_{21} ) t} ) - {e}^{( x - u ) \frac{( {λ}_{12} - {λ}_{21} )}{2 ϕ}} ( {g}_{22} ( x , t ) + {g}_{25} ( x , t ) + {g}_{27} ( x , t ) + {g}_{29} ( x , t ) + {g}_{210} ( x , t ) + {g}_{211} ( x , t ) + {g}_{212} ( x , t ) ) + {e}^{( x - u ) \frac{( {λ}_{12} - {λ}_{21} )}{2 ϕ}} ( \text{} {g}_{214} ( x , t ) + ( {g}_{215} ( x , t ) + ( {g}_{217} ( x , t ) + ( {g}_{218} ( x , t ) + ( {g}_{220} ( x , t ) + ( {g}_{222} ( x , t ) )$$

$$where$$

$${g}_{12 in} ( x , t , v ) = {e}^{- av} \frac{α {v}_{0} {I}_{1} [ α y ( v ) ]}{y ( v )} \qquad ( 72 )$$

$${g}_{13 in} ( x , t , v ) = 1 - {e}^{- ( {λ}_{12} + {λ}_{21} ) ( t - v )} \qquad ( 73 )$$

$${g}_{14} ( x , t , v ) = \frac{{λ}_{21}}{2 ( {λ}_{12} + {λ}_{21} )} {e}^{( x - u ) \frac{( {λ}_{12} - {λ}_{21} )}{2 ϕ}} {\int }_{{v}_{0}}^{t} {g}_{12 in} ( x , t , v ) {g}_{13 in} ( x , t , v ) dv \qquad ( 74 )$$

$${g}_{15} ( x , t ) = \frac{{λ}_{21}}{2 ( {λ}_{12} + {λ}_{21} )} {e}^{[ ( x - u ) \frac{( {λ}_{12} - {λ}_{21} )}{2 ϕ} - {av}_{0} ]} ( 1 - {e}^{- ( {λ}_{12} + {λ}_{21} ) ( t - {v}_{0} )} ) \qquad ( 75 )$$

$${g}_{16 in} ( x , v ) = \frac{1}{2} {e}^{- av} {I}_{0} [ α y ( v ) ] \qquad ( 76 )$$

$${g}_{17} ( x , t ) = \frac{{λ}_{21} ( {λ}_{12} - {λ}_{21} )}{2 ( {λ}_{12} + {λ}_{21} )} {e}^{( x - u ) \frac{( {λ}_{12} - {λ}_{21} )}{2 ϕ}} {\int }_{{v}_{0}}^{t} {g}_{16 in} ( x , t , v ) {g}_{13 in} ( x , t , v ) dv \qquad ( 77 )$$

$${g}_{18 in} ( x , t , v ) = \frac{1}{2} {e}^{- av} {I}_{0} [ α \text{?} ( v ) ] \qquad ( 78 )$$

$${g}_{19 in} ( x , t , v ) = \frac{1}{2} {e}^{- ( {λ}_{12} + {λ}_{21} ) ( t - v )} {e}^{- av} {I}_{0} [ α y ( v ) ] \qquad ( 79 )$$

$${g}_{111 in} ( x , t , v ) = ( α + \text{?} ) \text{?} \qquad ( 80 )$$

$${g}_{112 in} ( x , t , v ) = {e}^{- ( {λ}_{12} + {λ}_{21} ) ( t - v )} {e}^{av} \frac{α \text{?} [ α \text{?} ( v ) ]}{\text{?} ( v )} \qquad ( 81 )$$

$${g}_{110} ( x , t ) = \frac{α t}{{λ}_{12} \text{?} ( t )} \text{?} [ α \text{?} ( v ) ] + \frac{{λ}_{12} - {λ}_{21}}{2 {λ}_{12}} \text{?} [ α \text{?} ( t ) ] + ( {λ}_{12} - {λ}_{21} ) \text{?} [ \frac{{λ}_{12} {g}_{18 in} ( x , t , v )}{2 {λ}_{12} + {λ}_{21}} - \frac{{λ}_{21}^{2} {g}_{19 in} ( x , t , v )}{2 {λ}_{12} ( {λ}_{12} + {λ}_{21} )} ] dv \qquad ( 82 )$$

$${g}_{113} ( x , t ) = \frac{α \text{?}}{{λ}_{12} \text{?} ( t )} \text{?} [ \text{?} ] - \frac{1}{2 ( {λ}_{12} + {λ}_{21} )} [ {λ}_{12} \text{?} + \frac{{λ}_{21}^{2}}{2 {λ}_{12}} \text{?} ] + \frac{1}{2 ( {λ}_{12} + {λ}_{21} )} \text{?} [ {λ}_{12 {g}_{111 in}} ( x , t , v ) - \frac{{λ}_{21}^{2} {g}_{112 in} ( x , t , v )}{2 {λ}_{12} ( {λ}_{12} + {λ}_{21} )} ] \qquad ( 83 )$$

$$\text{?} \text{indicates text missing or illegible when filed}$$

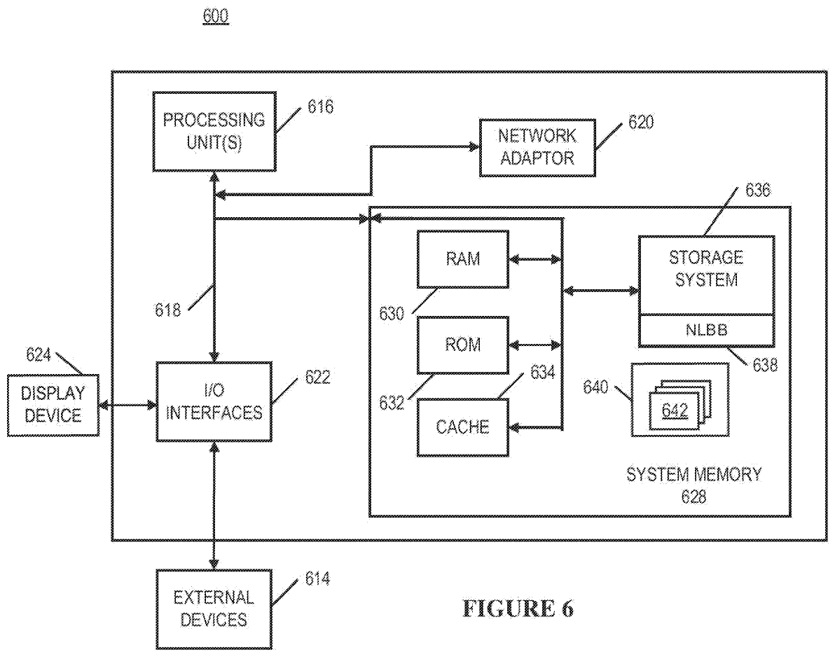

FIG. 6 illustrates an example compute node 600, which may be included in a high performance computing system. Components of compute node 600 may include, but are not limited to, one or more processing units 616, a system memory 628, and a bus 618 that couples various system components including system memory 628 to one or more processing units 616.

Bus 618 represents any one or more of several bus structure types, including a memory bus or memory controller, a peripheral bus, an accelerated graphics port, and a processor or local bus using any of a variety of bus architectures. Such architectures may include, but not be limited to, Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Compute node 600 may include various non-transitory computer-readable media, which may be any available non-transitory media accessible by computing system 600. The computer-readable media may include volatile and non-volatile non-transitory media as well as removable and non-removable non-transitory media.

System memory 628 may include non-transitory volatile memory, such as random access memory (RAM) 630 and cache memory 634. System memory 628 also may include non-transitory non-volatile memory including, but not limited to, read-only memory (ROM) 632 and storage system 636. Storage system 636 may be provided for reading from and writing to a nonremovable, non-volatile magnetic medium, which may include a hard drive or a Secure Digital (SD) card. In addition, a magnetic disk drive, not shown, may be provided for reading from and writing to a removable, non-volatile magnetic disk such as, for example, a floppy disk, and an optical disk drive for reading from or writing to a removable non-volatile optical disk such as a CD-ROM, DVD-ROM or other optical media. Storage system 636 also may include a solid state device (SSD), which may function as a node-local burst buffer 638. Each memory device may be connected to bus 618 by at least one data media interface. System memory 628 further may include instructions for processing unit(s) 616 to configure compute node 600 to perform functions of embodiments. For example, system memory 628 also may include, but not be limited to, processor instructions for an operating system, at least one application program, other program modules, program data, and an implementation of a networking environment.

Compute node 600 may communicate with one or more external devices 614 including, but not limited to, one or more displays, a keyboard, a pointing device, a speaker, at least one device that enables a user to interact with compute node 600, and any devices including, but not limited to, a network card, a modem, etc. that enable compute node 600 to communicate with one or more other computing devices. The communication can occur via Input/Output (I/O) interfaces 622. Compute node 600 can communicate with one or more networks including, but not limited to, a local area network (LAN), a general wide area network (WAN), a packet-switched data network (PSDN) and/or a public network such as, for example, the Internet, via network adapter 620. As depicted, network adapter 620 communicates with the other components of compute node 600 via bus 618.

It should be understood that, although not shown, other hardware and/or software components could be used in conjunction with compute node 600. Examples, include, but are not limited to, microcode, device drivers, redundant processing units, external disk drive arrays, RAID systems, tape drives, and data archival storage systems, etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or improvement over conventional technologies, or to enable others of ordinary skill in the art to understand the embodiments disclosed herein.

Aspects of the present invention are described herein with reference to flowchart illustrations and/or block diagrams of methods, apparatus (systems), and computer-readable storage devices having instructions stored therein for carrying out functions according to embodiments of the invention. It will be understood that each block of the flowchart illustrations and/or block diagrams, and combinations of blocks in the flowchart illustrations and/or block diagrams, can be implemented by computer readable program instructions. Each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Aspects of the present invention are described herein with reference to flowchart illustrations and/or block diagrams of methods, apparatus (systems), and computer-readable storage devices having instructions stored therein for carrying out functions according to embodiments of the invention. It will be understood that each block of the flowchart illustrations and/or block diagrams, and combinations of blocks in the flowchart illustrations and/or block diagrams, can be implemented by computer readable program instructions. Each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Aspects of the present invention are described herein with reference to flowchart illustrations and/or block diagrams of methods, apparatus (systems), and computer-readable storage devices having instructions stored therein for carrying out functions according to embodiments of the invention. It will be understood that each block of the flowchart illustrations and/or block diagrams, and combinations of blocks in the flowchart illustrations and/or block diagrams, can be implemented by computer readable program instructions. Each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

### APPENDIX A: APPROXIMATE SOLUTION FOR BESSEL FUNCTIONS

Given the modified Bessel function Iₙ(y), the power series

$${l}_{n}^{P} ( y )$$

(i.e., as y→0) is given by

$${I}_{n}^{P} ( y ) = {\sum }_{k = 0}^{∞} \frac{1}{\text{?} ( k + 1 ) \text{?} ( n + k + 1 )} {( \frac{y}{2} )}^{2 k + n} \qquad ( 105 )$$

$$\text{?} \text{indicates text missing or illegible when filed}$$

The asymptotic expansion for I₀(y) (i.e., as y→∞) is given by

$${I}_{0}^{A} ( y ) ∼ \frac{{e}^{y}}{\sqrt{2 π y}} \qquad ( 106 )$$

The asymptotic expansion for I₀(y) (i.e., as y→∞) for n≥1 is given by

$${I}_{n}^{A} ( y ) ∼ \frac{\text{?}}{\sqrt{2 π y}} {\sum }_{k = 0}^{∞} \frac{{( - 1 )}^{k} {n}^{2 k}}{( 2 k ) !! {y}^{k}} \qquad ( 107 )$$

$$\text{?} \text{indicates text missing or illegible when filed}$$

1. A method for performing real-time reliability analysis of node-local burst buffer architectures, the method comprising:
determining, by a computing device, an initial node-local burst buffer content at a start of a time period T;
receiving, by the computing device, a current node-local burst buffer content during the time period;
for each checkpoint/restart time interval, performing by the computing device:
estimating stochastic transition rates Δ=λ₁₂ and μ=λ₂₁, indicating when the node-local burst buffer is receiving and draining, respectively,
estimating input flow data rates of data entering the node-local burst buffer from a compute node, and
estimating drain data rates of the data leaving the node-local burst buffer to be stored to a parallel file system;
modeling, by the computing device, an average statistical reliability function of the node-local burst buffer within the time period T with respect to not exceeding a predetermined threshold value; and
performing an action, by the computing device, when the average statistical reliability function has a value that is less than a predefined value.

2. The method of claim 1, wherein the estimating the stochastic transition rates comprises:
estimating the λ by dividing a number of transitions to a node-local burst buffer receiving state by a cumulative amount of time that the node-local burst buffer is in the node-local burst buffer receiving state; and
estimating the μ by dividing a number of transitions to a node-local buffer draining state by a cumulative amount of time that the node-local burst buffer is in the node-local burst buffer draining state.

3. The method of claim 2, wherein when the λ and the μ exceed a predefined threshold, the method further comprises:
performing expectation maximization to estimate final values of the λ and the μ.

4. The method of claim 1, wherein:
W¹(x, t) is equal to a probability that an amount of data in the node-local burst buffer is less than or equal to a predefined threshold given that the node-local burst buffer is in a node-local burst buffer draining state, W²(x, t) is equal to a probability that an amount of data in the node-local burst buffer is less than or equal to the predefined threshold given that the node-local burst buffer is in a node-local burst buffer receiving state, and
calculating a value of the statistical reliability function based on the sum of W¹(x, t) and W²(x, t).

5. The method of claim 4, wherein:
when the node-local burst buffer is initially empty at a start of the each checkpoint/restart time interval,
$${W}^{1} ( x , t ) = \{ \begin{matrix}\frac{{λ}_{21} + {λ}_{12} {e}^{- ( {λ}_{12} + {λ}_{21} ) t}}{{λ}_{12} + {λ}_{21}} , 0 < t < x / {ϕ}_{2} \\ \frac{{λ}_{21} + {λ}_{12} {e}^{- ( {λ}_{12} + {λ}_{21} ) t}}{{λ}_{12} + {λ}_{21}} - ( \frac{1}{{λ}_{21} + {λ}_{12}} ) \text{?} \\ \text{?} {\int }_{0}^{t} \text{?} ( t - v , x ) h ( v , x ) dv , t > x / {ϕ}_{2}\end{matrix} ,$$
$${W}^{2} ( x , t ) = \{ \begin{matrix}\frac{{λ}_{12}}{{λ}_{12} + {λ}_{21}} ( 1 - \text{?} ) , 0 < t < x / {ϕ}_{2} \\ \frac{{λ}_{12}}{{λ}_{12} + {λ}_{21}} ( 1 - \text{?} ) - ( \frac{1}{{λ}_{21} + {λ}_{12}} ) \\ \text{?} {\int }_{0}^{t} \text{?} ( t - v , x ) g ( v , x ) dv , t > x / {ϕ}_{2}\end{matrix} , where$$
$${f}_{1} ( t , x ) = 1 - \text{?}$$
$$h ( t , x ) = \frac{{λ}_{12} {λ}_{21} ϕ - 2}{( {ϕ}_{2} - {ϕ}_{1} ) ( {λ}_{12} + {λ}_{21} )} {e}^{( - \frac{{λ}_{12} {ϕ}_{2} - {λ}_{21} {ϕ}_{1}}{{ϕ}_{2} - {ϕ}_{1}} t )} \times \{ \text{?} ( \text{?} ( x , t ) ) - \frac{1}{\text{?} ( x , t )} \text{?} ( \text{?} x , t ) ) \} ,$$
$$g ( t , x ) = δ ( t ) + \frac{\sqrt{- {λ}_{12} {λ}_{21} {ϕ}_{2} {ϕ}_{1}}}{{ϕ}_{2} - {ϕ}_{1}} {e}^{( - \frac{{λ}_{12} {ϕ}_{2} - {λ}_{21} {ϕ}_{1}}{{ϕ}_{2} - {ϕ}_{1}} t )} \times ( \text{?} ( x , t ) - \frac{1}{\text{?} ( x , t )} ) \text{?} ( \text{?} ( x , t ) ) ,$$
$$\text{?} ( x , t ) = \frac{2 t \sqrt{- {λ}_{12} {λ}_{21} {ϕ}_{1} {ϕ}_{2}}}{{ϕ}_{2} - {ϕ}_{1}} \text{?} ( x , t ) ,$$
$$\text{?} ( x , t ) = \sqrt{( 1 - ( \frac{1}{{ϕ}_{1}} - \frac{1}{{ϕ}_{2}} ) \frac{x}{t} )} ,$$
$$\text{?} \text{indicates text missing or illegible when filed}$$
and
Iₙ is a modified Bessel function of order n=0, 1, 2.

6. The method of claim 4, wherein:
an initial content of the node-local burst buffer is greater than the predefined threshold and |φ₁|=|φ₂|,
when 0<t≤v₀, W¹(x, t)=W²(x, t)=0,
$$when 0 < t < {\tilde{v}}_{0} ,$$
$${W}^{1} ( x , t ) = \frac{{λ}_{21}}{2 ( {λ}_{12} + {λ}_{21} )} \text{?} \times \{ 2 \text{?} sinh [ \text{?} ( t - {v}_{0} ) ] + \text{?} ( {λ}_{21} - {λ}_{12} ) {\int }_{{v}_{0}}^{t} sinh [ \text{?} ( v - t ) ] \text{?} [ \text{?} ( v ) ] dv - 2 \text{?} {\int }_{{v}_{0}}^{t} \frac{\text{?} {v}_{0} sinh [ \text{?} ( v - t ) ]}{y ( v )} \text{?} [ \text{?} ( v ) ] dv \}$$
$$and$$
$${W}^{2} ( \text{?} t ) = \frac{\text{?}}{2 ( {λ}_{12} + {λ}_{21} )} \times \{ {\int }_{{v}_{0}}^{t} \frac{( \text{?} + \text{?} ) \text{?} {v}_{0}}{y ( v )} \text{?} [ \text{?} y ( v ) ] dv - \frac{( {λ}_{12} - {λ}_{21} )}{2} \text{?} ( \text{?} + \text{?} ) \text{?} [ \text{?} y ( v ) ] dv + ( \text{?} + \text{?} ) - ( {λ}_{12} + {λ}_{21} ) \text{?} [ \text{?} y ( v ) ] \} \text{?} ,$$
$$when t > {\tilde{v}}_{0} ,$$
$${W}^{1} ( x , \text{?} ) = \frac{\text{?}}{{λ}_{12} + {λ}_{21}} ( {λ}_{21} \text{?} sinh [ \text{?} ( t - {v}_{0} ) ] + \frac{{λ}_{21}^{2} \text{?}}{2 {λ}_{12}} - \frac{{λ}_{12} \text{?}}{2} + \frac{\text{?} ( t )}{2 {λ}_{12}} ) + \frac{\text{?}}{{λ}_{12}} \times ( \frac{\text{?}}{y ( t )} \text{?} [ \text{?} ( t ) ] + \frac{( {λ}_{12} - {λ}_{21} ) \text{?} [ \text{?} ( t ) ]}{2} - \text{?} )$$
$$and$$
$${W}^{2} ( x , t ) = \frac{\text{?}}{{λ}_{12} + {λ}_{21}} \times \{ sinh [ \frac{\text{?} x}{ϕ} ] ( {λ}_{12} \text{?} - {λ}_{21} \text{?} ) + \frac{( {λ}_{12} + {λ}_{21} ) \text{?}}{2} ( \text{?} [ \text{?} ( t ) ] + \text{?} [ \text{?} ( t ) ] ) + \text{?} ( t ) \} ,$$
$$where$$
$$\text{?} = \frac{{λ}_{12} + {λ}_{21}}{2} , \text{?} = \sqrt{{λ}_{12} {λ}_{21}} ,$$
$${v}_{0} = \frac{1}{ϕ} ( \text{?} - x ) , \text{?} = \frac{1}{ϕ} ( u + x ) ,$$
$$y ( t ) = \sqrt{{t}^{2} - {v}_{0}^{2}} , \text{?} ( t ) = \sqrt{{t}^{2} - {\tilde{v}}_{0}^{2}} ,$$
$$\text{?} ( t ) = {α}^{2} \text{?} \{ ( {λ}_{21} - {λ}_{12} ) {I}_{0} [ α y ( v ) ] - \frac{2 α {v}_{0} \text{?} [ \text{?} y ( v ) ]}{y ( v )} \} \text{?} sinh [ \text{?} ( t - v ) ] dv + ( {λ}_{12} - {λ}_{21} ) \text{?} ( {λ}_{21}^{2} \text{?} - {λ}_{12}^{2} \text{?} ) {I}_{0} [ \text{?} ( v ) ] dv + \text{?} \frac{\text{?}}{\text{?} ( v )} ( {λ}_{21}^{2} \text{?} - {λ}_{12}^{2} \text{?} ) {I}_{0} [ \text{?} ( v ) ] dv ,$$
$$and$$
$$\text{?} ( t ) = \frac{1}{4} {\int }_{{v}_{0}}^{t} ( {λ}_{21} \text{?} + {λ}_{12} \text{?} ) \times [ {I}_{0} [ α y ( v ) ] ( {λ}_{21} - {λ}_{12} ) - \frac{2 α \text{?} [ α y ( v ) ]}{y ( v )} ] dv + \frac{1}{4} \text{?} ( {λ}_{21} \text{?} + {λ}_{12} \text{?} ) \times [ {I}_{0} [ α \text{?} ( v ) ] ( {λ}_{21} - {λ}_{12} ) - \frac{2 α \text{?} [ α y ( v ) ]}{\text{?} ( v )} ] dv ,$$
$$\text{?} \text{indicates text missing or illegible when filed}$$
and Iₙ are modified Bessel functions of an order n=0, 1.

7. The method of claim 4, wherein:
an initial content of the node-local burst buffer is less than or equal to the predefined threshold and |φ₁|=|φ₂|,
$$when 0 < t \leq {v}_{0} ,$$
$${W}^{1} ( x , t ) = \frac{{λ}_{21}}{{λ}_{12} + {λ}_{21}} ( 1 - {e}^{- ( {λ}_{12} + {λ}_{21} ) t} )$$
$${W}^{2} ( x , t ) = \frac{{λ}_{12}}{{λ}_{12} + {λ}_{21}} + \frac{{λ}_{21}}{{λ}_{12} + {λ}_{21}} ( 1 - {e}^{- ( {λ}_{12} + {λ}_{21} ) t} )$$
$$When 0 < t \leq {\tilde{v}}_{0} ,$$
$${W}^{1} ( x , t ) = \frac{{λ}_{21}}{{λ}_{12} + {λ}_{21}} ( 1 - {e}^{- ( {λ}_{12} + {λ}_{21} ) t} ) - ( {g}_{14} ( x , t ) + {g}_{15} ( x , t ) + {g}_{17} ( x , t ) ) ,$$
$${W}^{2} ( x , t ) = \frac{{λ}_{12}}{{λ}_{12} + {λ}_{21}} + \frac{{λ}_{21}}{{λ}_{12} + {λ}_{21}} ( 1 - {e}^{- ( {λ}_{12} + {λ}_{21} ) t} ) \text{?} ( {g}_{22} ( x , t ) + {g}_{25} ( x , t ) + {g}_{27} ( x , t ) + {g}_{29} ( x , t ) + {g}_{210} ( x , t ) + {g}_{211} ( x , t ) + {g}_{212} ( x , t ) )$$
$$when t > {\tilde{v}}_{0} ,$$
$${W}^{1} ( x , t ) = \frac{{λ}_{21}}{{λ}_{12} + {λ}_{21}} ( 1 - {e}^{- ( {λ}_{12} + {λ}_{21} ) t} ) + \text{?} ( {g}_{110} ( x , t ) - {g}_{113} ( x , t ) ) - ( {g}_{14} ( x , t ) + {g}_{15} ( x , t ) + {g}_{17} ( x , t ) )$$
$$and$$
$${W}^{2} ( x , t ) = \frac{{λ}_{12}}{{λ}_{12} + {λ}_{21}} + \frac{{λ}_{21}}{{λ}_{12} + {λ}_{21}} ( 1 - {e}^{- ( {λ}_{12} + {λ}_{21} ) t} ) - \text{?} ( {g}_{22} ( x , t ) + {g}_{25} ( x , t ) + {g}_{27} ( x , t ) + {g}_{29} ( x , t ) + {g}_{210} ( x , t ) + {g}_{211} ( x , t ) + {g}_{212} ( x , t ) ) + \text{?} ( {g}_{214} ( x , t ) + {g}_{215} ( x , t ) + {g}_{217} ( x , t ) + {g}_{218} ( x , t ) + {g}_{220} ( x , t ) + {g}_{222} ( x , t ) )$$
$$where$$
$${g}_{12 in} ( x , t , v ) = {e}^{- av} \frac{α {v}_{0} \text{?} [ α y ( v ) ]}{y ( v )}$$
$${g}_{13 in} ( x , t , v ) = 1 - {e}^{- ( {λ}_{12} + {λ}_{21} ) ( t - v )}$$
$${g}_{14} ( x , t , v ) = \frac{{λ}_{21}}{2 ( {λ}_{12} + {λ}_{21} )} {e}^{( x - u ) \frac{( {λ}_{12} - {λ}_{21} )}{2 ϕ}} {\int }_{{v}_{0}}^{t} {g}_{12 in} ( x , t , v ) {g}_{13 in} ( x , t , v ) dv$$
$${g}_{15} ( x , t ) = \frac{{λ}_{21}}{2 ( {λ}_{12} + {λ}_{21} )} {e}^{[ ( x - u ) \frac{( {λ}_{12} - {λ}_{21} )}{2 ϕ} - {av}_{0} ]} ( 1 - {e}^{- ( {λ}_{12} + {λ}_{21} ) ( t - {v}_{0} )} )$$
$${g}_{16 in} ( x , v ) = \frac{1}{2} {e}^{- av} \text{?} [ α y ( v ) ]$$
$${g}_{17} ( x , t ) = \frac{{λ}_{21} ( {λ}_{12} - {λ}_{21} )}{2 ( {λ}_{12} + {λ}_{21} )} \text{?} {\int }_{{v}_{0}}^{t} {g}_{16 in} ( x , t , v ) {g}_{13 in} ( x , t , v ) dv$$
$${g}_{18 in} ( x , t , v ) = \frac{1}{2} {e}^{- av} \text{?} [ α \text{?} ( v ) ]$$
$${g}_{19 in} ( x , t , v ) = \frac{1}{2} {e}^{- ( {λ}_{12} + {λ}_{21} ) ( t - v )} {e}^{- av} \text{?} [ α y ( v ) ]$$
$${g}_{111 in} ( x , t , v ) = ( α + \text{?} ) {e}^{- av} \frac{\text{?} [ α y ( v ) ]}{\text{?} ( v )}$$
$${g}_{112 in} ( x , t , v ) = {e}^{- ( {λ}_{12} + {λ}_{21} ) ( t - v )} {e}^{- av} \frac{α \text{?} [ α \text{?} ( v ) ]}{\text{?} ( v )}$$
$${g}_{110} ( x , t ) = \frac{\text{?}}{{λ}_{12} \text{?} ( t )} \text{?} [ \text{?} ( v ) ] + \frac{{λ}_{12} - {λ}_{21}}{2 {λ}_{12}} \text{?} [ \text{?} ( t ) ] + ( {λ}_{12} - {λ}_{21} ) \text{?} [ \frac{\text{?} ( x , t , v )}{2 {λ}_{12} + {λ}_{21}} - \frac{\text{?} ( x , t , v )}{2 {λ}_{12} ( {λ}_{12} + {λ}_{21} )} ] dv$$
$${g}_{113} ( x , t ) = \frac{\text{?}}{{λ}_{12} \text{?} ( t )} \text{?} [ \text{?} ( t ) ] - \frac{1}{2 ( {λ}_{12} + {λ}_{21} )} [ \text{?} + \frac{{λ}_{21}^{2}}{2 {λ}_{12}} \text{?} ] + \frac{1}{2 ( {λ}_{12} + {λ}_{21} )} \text{?} [ \text{?} ( x , t , v ) - \frac{\text{?} ( x , t , v )}{2 {λ}_{12} ( {λ}_{12} + {λ}_{21} )} ]$$
$${g}_{22} ( x , t ) = \frac{1}{2} \text{?} [ α y ( t ) ]$$
$${g}_{23 in} ( x , t , v ) = \frac{1}{2} \text{?} [ α y ( v ) ]$$
$${g}_{24 in} ( x , t , v ) = {e}^{- ( {λ}_{12} + {λ}_{21} ) ( t - v )}$$
$${g}_{25} ( x , t ) = \frac{( {λ}_{12} - {λ}_{21} )}{2} \text{?} {g}_{23 in} ( x , t , v ) {g}_{24 in} ( x , t , v ) dv$$
$${g}_{26 in} ( x , t , v ) = 1 - {e}^{- ( {λ}_{12} + {λ}_{21} ) ( t - v )}$$
$${g}_{27} ( x , t ) = \frac{{λ}_{12} ( {λ}_{12} - {λ}_{21} )}{2 ( {λ}_{12} - {λ}_{21} )} \text{?} {g}_{23 in} ( x , t , v ) {g}_{26 in} ( x , t , v ) dv$$
$${g}_{28 in} ( x , t , v ) = \text{?} \frac{\text{?} [ α y ( v ) ]}{y ( v )}$$
$${g}_{29} ( x , t ) = \frac{{λ}_{12}}{( {λ}_{12} - {λ}_{21} )} \text{?} {g}_{28 in} ( x , t , v ) {g}_{26 in} ( x , t , v ) dv$$
$${g}_{210} ( x , t ) = \frac{{λ}_{12}}{( {λ}_{12} + {λ}_{21}} \text{?} ( 1 - {e}^{- ( {λ}_{12} + {λ}_{21} ) ( t - {v}_{0} )} )$$
$${g}_{211} ( x , t ) = \frac{1}{2} \text{?} {g}_{28 in} ( x , t , v ) {g}_{24 in} ( x , t , v ) dv$$
$${g}_{212} ( x , t ) = \frac{1}{2} {e}^{[ - ( {λ}_{12} + {λ}_{21} ) ( t - {v}_{0} ) - {av}_{0} ]}$$
$${g}_{213 in} ( x , t , v ) = \text{?} \frac{\text{?} [ α \text{?} ( v ) ]}{y ( v )}$$
$${g}_{214} ( x , t ) = \frac{{λ}_{21}}{2 ( {λ}_{12} - {λ}_{21} )} \text{?} {g}_{213 in} ( x , t , v ) dv$$
$${g}_{215} ( x , t ) = - \frac{{λ}_{21}}{2 ( {λ}_{12} - {λ}_{21} )} \text{?}$$
$${g}_{216 in} ( x , t , v ) = \text{?} \frac{α \text{?} [ α \text{?} ( v ) ]}{\text{?} ( v )}$$
$${g}_{217} ( x , t ) = \frac{{λ}_{21}}{2 ( {λ}_{12} - {λ}_{21} )} \text{?} {g}_{216 in} ( x , t , v ) dv + \text{?}$$
$${g}_{218} ( x , t ) = \frac{1}{2} {e}^{- at} \text{?} [ α \text{?} ( t ) ]$$
$${g}_{219 in} ( x , t , v ) = \frac{1}{2} {e}^{- av} {e}^{- ( {λ}_{12} + {λ}_{21} ) ( t - v )} \text{?} [ \text{?} ( v ) ]$$
$${g}_{220} ( x , t ) = \frac{{λ}_{21} ( {λ}_{12} - {λ}_{21} )}{2 ( {λ}_{12} + {λ}_{21} )} \text{?} {g}_{219 in} ( x , t , v ) dv$$
$${g}_{221 in} ( x , t , v ) = \frac{1}{2} {e}^{- a v} \text{?} [ α \text{?} ( v ) ]$$
$${g}_{222} ( x , t ) = \frac{{λ}_{12} ( {λ}_{12} - {λ}_{21} )}{2 ( {λ}_{12} + {λ}_{21} )} \text{?} {g}_{221 in} ( x , t , v ) dv$$
$$\text{?} \text{indicates text missing or illegible when filed}$$

8. The method of claim 4, further comprising:
calculating \tilde{λ}₁₂ from Δtλ₁₂ and \tilde{λ}₂₁ from Δtλ₂₁, wherein Δt=tₖ₊₁−tₖ∀tₖ∈ [symbol] .

9. A computing device for performing real-time reliability analysis of node-local burst buffer architectures, the computing device comprising:
at least one processor; and
a memory connected with the at least one processor; and
a node-local burst buffer, wherein:
the at least one processor is configured to perform operations comprising:
determining an initial node-local burst buffer content at a start of a time period T;
receiving a current node-local burst buffer content during the time period;
for each checkpoint/restart time interval, performing:
estimating stochastic transition rates λ₁₂ and μ, indicating when the node-local burst buffer is receiving and draining, respectively,
estimating input flow data rates of data entering the node-local burst buffer from a compute node, and
estimating drain data rates of the data leaving the node-local burst buffer to a parallel file system;
modeling an average statistical reliability function of the node-local burst buffer within the time period T with respect to not exceeding a predetermined threshold value; and
performing an action when the average statistical reliability function has a value that is less than a predefined value.

10. The computing device of claim 9, wherein the estimating the stochastic transition rates comprises:
estimating the λ=λ₁₂ by dividing the number of transitions to a node-local buffer receiving state by a cumulative amount of time that the node-local burst buffer is in the node-local burst buffer receiving state; and
estimating the μ=λ₂₁ by dividing the number of transitions to the node-local buffer draining state by a cumulative amount of time that the node-local burst buffer is in the node-local burst buffer draining state.

11. The computing device of claim 10, wherein when the λ=λ₁₂ and the μ=λ₂₁ exceed a predefined threshold, the method further comprises:
performing expectation maximization to estimate final values of λ and μ.

12. The computing device of claim 9, wherein:
W¹(x, t) is equal to the probability that an amount of data in the node-local burst buffer is less than or equal to a predefined threshold given that the node-local burst buffer is in a node-local burst buffer draining state;
W²(x, t) is equal to the probability that an amount of data in the node-local burst buffer is less than or equal to the predefined threshold given that the node-local burst buffer is in a node-local burst buffer receiving state; and
calculating a value of the statistical reliability function based on a sum of W¹(x, t) and W²(x, t).

13. The computing device of claim 12, wherein:
the node-local burst buffer is initially empty at a start of the each checkpoint/restart time interval,
$${W}^{1} ( x , t ) = \{ \begin{matrix}\frac{{λ}_{21} + {λ}_{12} \text{?}}{{λ}_{12} + {λ}_{21}} , 0 < t < x / {ϕ}_{2} \\ \frac{{λ}_{21} + {λ}_{12} \text{?}}{{λ}_{12} + {λ}_{21}} - ( \frac{1}{{λ}_{21} + {λ}_{12}} ) \times \\ \text{?} ( t - v , x ) h ( v , x ) dv , \text{?} > x / {ϕ}_{2}\end{matrix}$$
$${W}^{2} ( x , t ) = \{ \begin{matrix}\frac{{λ}_{12}}{{λ}_{12} + {λ}_{21}} ( 1 - \text{?} ) , 0 < \text{?} < x / {ϕ}_{2} \\ \frac{{λ}_{12}}{{λ}_{12} + {λ}_{21}} ( 1 - \text{?} ) - ( \frac{{λ}_{12}}{{λ}_{21} + {λ}_{12}} ) \\ \text{?} ( t - v , x ) g ( v , x ) dv , \text{?} > x / {ϕ}_{2}\end{matrix} , where$$
$$\text{?} ( t , x ) = 1 - \text{?}$$
$$h ( t , x ) = \frac{{λ}_{12} {λ}_{21} {ϕ}_{2}}{( {ϕ}_{2} - {ϕ}_{1} ) ( {λ}_{12} + {λ}_{21} )} \text{?} \times \{ \text{?} ( \text{?} ( x , t ) ) - \frac{1}{\text{?} ( x , t )} \text{?} ( \text{?} ( x , t ) ) \} \text{?}$$
$$g ( t , x ) = δ ( t ) + \frac{\sqrt{- {λ}_{12} {λ}_{21} {ϕ}_{2} {ϕ}_{1}}}{{ϕ}_{2} - {ϕ}_{1}} \text{?} \times ( \text{?} ( x , t ) - \frac{1}{\text{?} ( x , t )} ) \text{?} ( \text{?} ( x , t ) ) ,$$
$$\text{?} ( x , t ) = \frac{2 t \sqrt{- {λ}_{12} {λ}_{21} {ϕ}_{1} {ϕ}_{2}}}{{ϕ}_{2} - {ϕ}_{1}} \text{?} ( x , t ) ,$$
$$\text{?} = \sqrt{( 1 - ( \frac{1}{{ϕ}_{1}} - \frac{1}{{ϕ}_{2}} ) \frac{x}{t} )} ,$$
$$\text{?} \text{indicates text missing or illegible when filed}$$
and
Iₙ is a modified Bessel function of order n=0, 1, 2.

14. The computing device of claim 12, wherein:
an initial content of the node-local burst buffer is greater than the predefined threshold and |φ₁|=|φ₂|,
when 0<t≤v₀, W¹(x, t)=W²(x, t)=0,
$${W}^{1} ( x , t ) = \frac{{λ}_{21}}{2 ( {λ}_{12} + {λ}_{21} )} \text{?} \times \{ \text{?} sinh [ \text{?} - {v}_{0} ) ] + \text{?} ( {λ}_{21} - {λ}_{12} ) \text{?} sinh [ \text{?} ( v - t ) ] \text{?} [ \text{?} ] dv - 2 \text{?} \frac{\text{?} sinh [ \text{?} ( v - t ) ]}{\text{?}} \text{?} [ \text{?} ] dv \}$$
$$and$$
$${W}^{2} ( x , \text{?} ) = \frac{\text{?}}{2 ( {λ}_{12} + {λ}_{21} )} \times \{ \text{?} \frac{\text{?}}{\text{?}} \text{?} dv - \frac{( {λ}_{12} - {λ}_{21} )}{2} \text{?} ( \text{?} + \text{?} ) \text{?} dv + ( \text{?} + \text{?} ) - ( {λ}_{12} + \text{?} ) \text{?}$$
$$when t > {\tilde{v}}_{0} ,$$
$${W}^{1} ( x , t ) = \frac{\text{?}}{{λ}_{12} + {λ}_{21}} ( {λ}_{21} \text{?} sinh [ \text{?} ] + \frac{{λ}_{21} \text{?}}{2 {λ}_{12}} - \frac{{λ}_{12} \text{?}}{2} + \frac{\text{?}}{2 {λ}_{12}} ) + \frac{\text{?}}{{λ}_{12}} \times ( \frac{\text{?}}{\text{?}} \text{?} + \frac{\text{?}}{2} - \text{?} )$$
$$and$$
$${W}^{2} ( x , t ) = \frac{\text{?}}{{λ}_{12} + {λ}_{21}} \times \{ sinh [ \frac{\text{?}}{\text{?}} ] ( {λ}_{12} \text{?} - {λ}_{21} \text{?} ) + \frac{( {λ}_{12} + {λ}_{21} ) \text{?}}{2} \text{?}$$
$$where$$
$$\text{?} = \frac{{λ}_{12} + {λ}_{21}}{2} , \text{?} = \sqrt{{λ}_{12} {λ}_{21}} ,$$
$$\text{?} = \frac{1}{\text{?}} ( \text{?} - x ) , \text{?} = \frac{1}{\text{?}} ( \text{?} - x )$$
$$y ( t ) = \sqrt{{t}^{2} - {v}_{0}^{2}} , \text{?} ( t ) = \sqrt{{t}^{2} - \text{?}} ,$$
$$\text{?} = \text{?} \{ ( {λ}_{21} - {λ}_{12} ) \text{?} - \frac{\text{?}}{\text{?}} \text{?} sinh \text{?} dv + ( {λ}_{12} - {λ}_{21} ) \text{?} ( {λ}_{21}^{2} \text{?} - {λ}_{12}^{2} \text{?} ) \text{?} dv + \text{?} \frac{\text{?}}{\text{?}} ( {λ}_{21}^{2} \text{?} - {λ}_{12}^{2} \text{?} ) \text{?} dv \text{?}$$
$$and$$
$$\text{?} = \frac{1}{4} \text{?} ( {λ}_{21} \text{?} + {λ}_{12} \text{?} ) \times [ \text{?} ( {λ}_{21} - {λ}_{12} ) - \frac{\text{?}}{\text{?}} ] dv + \frac{1}{4} \text{?} ( {λ}_{21} \text{?} + {λ}_{12} \text{?} ) \times [ \text{?} ( {λ}_{21} - {λ}_{12} ) - \frac{\text{?}}{\text{?}} ] dv ,$$
$$\text{?} \text{indicates text missing or illegible when filed}$$
and Iₙ are modified Bessel functions of an order n=0, 1.

15. The computing device of claim 12, wherein:
an initial content of the node-local burst buffer is less than or equal to the predefined threshold and |φ₁|=|φ₂|,
$$when 0 < t \leq {v}_{0} ,$$
$${W}^{1} ( x , t ) = \frac{{λ}_{21}}{{λ}_{12} + {λ}_{21}} ( 1 - \text{?} )$$
$${W}^{2} ( x , t ) = \frac{{λ}_{12}}{{λ}_{12} + {λ}_{21}} + \frac{{λ}_{21}}{{λ}_{12} + {λ}_{21}} ( 1 - \text{?} )$$
$$when {v}_{0} < t \leq {\tilde{v}}_{0} ,$$
$${W}^{1} ( x , t ) = \frac{{λ}_{21}}{{λ}_{12} + {λ}_{21}} ( 1 - \text{?} ) - ( {g}_{14} ( x , t ) + {g}_{15} ( x , t ) + {g}_{17} ( x , t ) )$$
$${W}^{2} ( x , t ) = \frac{{λ}_{12}}{{λ}_{12} + {λ}_{21}} + \frac{{λ}_{21}}{{λ}_{12} + {λ}_{21}} ( 1 - \text{?} ) - \text{?} ( {g}_{22} ( x , t ) + {g}_{25} ( x , t ) + {g}_{27} ( x , t ) + {g}_{29} ( x , t ) + {g}_{210} ( x , t ) + {g}_{211} ( x , t ) + {g}_{212} ( x , t ) )$$
$$when t > {\tilde{v}}_{0} ,$$
$${W}^{1} ( x , t ) = \frac{{λ}_{21}}{{λ}_{12} + {λ}_{21}} ( 1 - \text{?} ) + \text{?} ( {g}_{110} ( x , t ) - {g}_{113} ( x , t ) ) - ( {g}_{14} ( x , t ) + {g}_{15} ( x , t ) + {g}_{17} ( x , t ) )$$
$$and$$
$${W}^{2} ( x , t ) = \frac{{λ}_{12}}{{λ}_{12} + {λ}_{21}} + \frac{{λ}_{21}}{{λ}_{12} + {λ}_{21}} ( 1 - \text{?} ) - \text{?} ( {g}_{22} ( x , t ) + {g}_{25} ( x , t ) + {g}_{27} ( x , t ) + {g}_{29} ( x , t ) + {g}_{210} ( x , t ) + {g}_{211} ( x , t ) + {g}_{212} ( x , t ) ) + \text{?} ( \text{} {g}_{214} ( x , t ) + ( {g}_{215} ( x , t ) + ( {g}_{217} ( x , t ) + ( {g}_{218} ( x , t ) + ( {g}_{220} ( x , t ) + ( {g}_{222} ( x , t ) )$$
$$where$$
$${g}_{12 in} ( x , t , v ) = {e}^{- av} \frac{α {v}_{0} \text{?} [ α y ( v ) ]}{y ( v )}$$
$${g}_{13 in} ( x , t , v ) = 1 - {e}^{- ( {λ}_{12} + {λ}_{21} ) ( t - v )}$$
$${g}_{14} ( x , t , v ) = \frac{{λ}_{21}}{2 ( {λ}_{12} + {λ}_{21} )} {e}^{( x - u ) \frac{( {λ}_{12} - {λ}_{21} )}{2 ϕ}} {\int }_{{v}_{0}}^{t} {g}_{12 in} ( x , t , v ) {g}_{13 in} ( x , t , v ) dv$$
$${g}_{15} ( x , t ) = \frac{{λ}_{21}}{2 ( {λ}_{12} + {λ}_{21} )} {e}^{[ ( x - u ) \frac{( {λ}_{12} - {λ}_{21} )}{2 ϕ} - {av}_{0} ]} ( 1 - {e}^{- ( {λ}_{12} + {λ}_{21} ) ( t - {v}_{0} )} )$$
$${g}_{16 in} ( x , v ) = \frac{1}{2} {e}^{- av} \text{?} [ α y ( v ) ]$$
$${g}_{17} ( x , t ) = \frac{{λ}_{21} ( {λ}_{12} - {λ}_{21} )}{2 ( {λ}_{12} + {λ}_{21} )} {e}^{( x - u ) \frac{( {λ}_{12} - {λ}_{21} )}{2 ϕ}} {\int }_{{v}_{0}}^{t} {g}_{16 in} ( x , t , v ) {g}_{13 in} ( x , t , v ) dv$$
$${g}_{18 in} ( x , t , v ) = \frac{1}{2} {e}^{- av} \text{?} [ α \text{?} ( v ) ]$$
$${g}_{19 in} ( x , t , v ) = \frac{1}{2} \text{?} {e}^{- av} \text{?} [ α y ( v ) ]$$
$${g}_{111 in} ( x , t , v ) = ( α + \text{?} ) \text{?} \frac{\text{?}}{\text{?}}$$
$${g}_{112 in} ( x , t , v ) = \text{?} {e}^{- av} \frac{α \text{?} [ α \text{?} ( v ) ]}{\text{?} ( v )}$$
$${g}_{110} ( x , \text{?} ) = \frac{α t}{{λ}_{12} \text{?} ( t )} \text{?} [ α \text{?} ( v ) ] + \frac{{λ}_{12} - {λ}_{21}}{2 {λ}_{12}} \text{?} [ α \text{?} ( t ) ] + ( {λ}_{12} - {λ}_{21} ) \text{?} [ \frac{{λ}_{12} {g}_{18 in} ( x , t , v )}{2 {λ}_{12} + {λ}_{21}} - \frac{{λ}_{21}^{2} {g}_{19 in} ( x , t , v )}{2 {λ}_{12} ( {λ}_{12} + {λ}_{21} )} ] dv$$
$${g}_{113} ( x , t ) = \frac{\text{?}}{{λ}_{12} \text{?}} \text{?} [ \text{?} ] - \frac{1}{2 ( {λ}_{12} + {λ}_{21} )} [ {λ}_{12} \text{?} + \frac{{λ}_{21}^{2}}{2 {λ}_{12}} \text{?} ] + \frac{1}{2 ( {λ}_{12} + {λ}_{21} )} \text{?} [ {λ}_{12 {g}_{111 in}} ( x , t , v ) - \frac{{λ}_{21}^{2} {g}_{112 in} ( x , t , v )}{2 {λ}_{12} ( {λ}_{12} + {λ}_{21} )} ]$$
$${g}_{22} ( x , t ) = \frac{1}{2} \text{?} [ α y ( t ) ]$$
$${g}_{23 in} ( x , t , v ) = \frac{1}{2} {e}^{- av} \text{?} [ α y ( v ) ]$$
$${g}_{24 in} ( x , t , v ) = {e}^{- ( {λ}_{12} + {λ}_{21} ) ( t - v )}$$
$${g}_{25} ( x , t ) = \frac{( {λ}_{12} - {λ}_{21} )}{2} \text{?} {g}_{23 in} ( x , t , v ) {g}_{24 in} ( x , t , v ) dv$$
$${g}_{26 in} ( x , t , v ) = 1 - \text{?}$$
$${g}_{27} ( x , t ) = \frac{{λ}_{12} ( {λ}_{12} - {λ}_{21} )}{2 ( {λ}_{12} - {λ}_{21} )} \text{?} {g}_{23 in} ( x , t , v ) {g}_{26 in} ( x , t , v ) dv$$
$${g}_{28 in} ( x , t , v ) = {e}^{- av} \frac{\text{?} [ α y ( v ) ]}{y ( v )}$$
$${g}_{29} ( x , t ) = \frac{{λ}_{12}}{( {λ}_{12} - {λ}_{21} )} \text{?} {g}_{28 in} ( x , t , v ) {g}_{26 in} ( x , t , v ) dv$$
$${g}_{210} ( x , t ) = \frac{{λ}_{12}}{( {λ}_{12} + {λ}_{21}} {e}^{- {av}_{0}} ( 1 - {e}^{- ( {λ}_{12} + {λ}_{21} ) ( t - {v}_{0} )} )$$
$${g}_{211} ( x , t ) = \frac{1}{2} \text{?} {g}_{28 in} ( x , t , v ) {g}_{24 in} ( x , t , v ) dv$$
$${g}_{212} ( x , t ) = \frac{1}{2} {e}^{[ - ( {λ}_{12} + {λ}_{21} ) ( \text{?} - {v}_{0} ) - {av}_{0} ]}$$
$${g}_{213 in} ( x , t , v ) = \text{?} {e}^{- av} \frac{\text{?} [ α \text{?} ( v ) ]}{y ( v )}$$
$${g}_{214} ( x , t ) = \frac{{λ}_{21}}{2 ( {λ}_{12} - {λ}_{21} )} \text{?} {g}_{213 in} ( x , t , v ) dv$$
$${g}_{215} ( x , t ) = - \frac{{λ}_{21}}{2 ( {λ}_{12} - {λ}_{21} )} \text{?}$$
$${g}_{216 in} ( x , t , v ) = {e}^{- av} \frac{α \text{?} [ α \text{?} ( v ) ]}{\text{?} ( v )}$$
$${g}_{217} ( x , t ) = \frac{{λ}_{21}}{2 ( {λ}_{12} - {λ}_{21} )} \text{?} {g}_{216 in} ( x , t , v ) dv + \text{?}$$
$${g}_{218} ( x , t ) = \frac{1}{2} {e}^{- at} \text{?} [ α \text{?} ( t ) ]$$
$${g}_{219 in} ( x , t , v ) = \frac{1}{2} {e}^{- av} \text{?} [ \text{?} ( v ) ]$$
$${g}_{220} ( x , t ) = \frac{{λ}_{21} ( {λ}_{12} - {λ}_{21} )}{2 ( {λ}_{12} + {λ}_{21} )} \text{?} {g}_{219 in} ( x , t , v ) dv$$
$${g}_{221 in} ( x , t , v ) = \frac{1}{2} {e}^{- a v} \text{?} [ α \text{?} ( v ) ]$$
$${g}_{222} ( x , t ) = \frac{{λ}_{12} ( {λ}_{12} - {λ}_{21} )}{2 ( {λ}_{12} + {λ}_{21} )} \text{?} {g}_{221 in} ( x , t , v ) dv .$$
$$\text{?} \text{indicates text missing or illegible when filed}$$

16. The computing device of claim 12, wherein the operations further comprise:
calculating \tilde{λ}₁₂ from Δtλ₁₂ and \tilde{λ}₂₁ from Δtλ₂₁, wherein Δt=tₖ₊₁−tₖ∀tₖ∈ [symbol] .

17. A non-transitory computer-readable medium having instructions recorded thereon for a processor of a computing device to perform operations comprising:
determining an initial node-local burst buffer content at a start of a time period T;
receiving a current node-local burst buffer content during the time period;
for each checkpoint/restart time interval, performing:
estimating stochastic transition rates λ=λ₁₂ and μ=λ₂₁, indicating when the node-local burst buffer is receiving and draining, respectively,
estimating input flow data rates of data entering the node-local burst buffer from a compute node, and
estimating drain data rates of the data leaving the node-local burst buffer to be stored to a parallel file system;
modeling an average statistical reliability function of the node-local burst buffer within the time period T with respect to not exceeding a predetermined threshold value; and
performing an action when the average statistical reliability function has a value that is less than a predefined threshold value.

18. The non-transitory computer-readable medium of claim 17, wherein the estimating the stochastic transition rates comprises:
estimating the λ=λ₁₂ by dividing a number of transitions to a node-local buffer receiving state by a cumulative amount of time that the node-local burst buffer is in the node-local burst buffer receiving state; and
estimating the μ=λ₂₁ by dividing a number of transitions to the node-local buffer draining state by a cumulative amount of time that the node-local burst buffer is in the node-local burst buffer draining state.

19. The non-transitory computer-readable medium of claim 18, wherein when the λ and the μ exceed a predefined threshold, the method further comprises:
performing expectation maximization to estimate final values of λ and μ.

20. The non-transitory computer-readable medium of claim 17, wherein:
W¹(x, t) is equal to the probability that an amount of data in the node-local burst buffer is less than or equal to a predefined threshold given that the node-local burst buffer is in a node-local burst buffer draining state;
W²(x, t) is equal to the probability that an amount of data in the node-local burst buffer is less than or equal to the predefined threshold given that the node-local burst buffer is in a node-local burst buffer receiving state; and
calculating a value of the statistical reliability function based on a sum of W¹(x, t) and W²(x, t).

21-23. (canceled)
